(19) United States
(12) Patent Application Publication
(10) Pub. No.: US 2015/0015840 A1
(43) Pub. Date: Jan. 15, 2015

(54) LIQUID CRYSTAL DISPLAY DEVICE AND MANUFACTURING METHOD FOR THE SAME, AND LIQUID CRYSTAL ALIGNMENT REGULATION FORCE DECISION METHOD

(71) Applicant: Japan Display Inc., Tokyo (JP)

(72) Inventors: Yasuo IMANISHI, Tokyo (JP); Yosuke HYODO, Tokyo (JP); Chikae MATSUI, Tokyo (JP); Hidehiro SONODA, Tokyo (JP); Noboru KUNIMATSU, Tokyo (JP)

(21) Appl. No.: 14/325,703

(22) Filed: Jul. 8, 2014

(30) Foreign Application Priority Data
Jul. 10, 2013 (JP) 2013-144386

(51) Int. Cl. G02F 1/1337; G02F 1/1339

(52) U.S. Cl. CPC G02F 1/133723; G02F 1/133788; G02F 1/1339
USPC 349/123; 438/30

(57) ABSTRACT

A liquid crystal display device includes a TFT substrate and a counter substrate on each of which an alignment film is formed and a liquid crystal interposed and held between the alignment films of the TFT and counter substrate, wherein the alignment film is made of a material capable of applying liquid crystal alignment regulation force by polarized light irradiation, a convex structure is formed on the TFT substrate or the counter substrate, and the alignment film is applied the liquid crystal alignment regulation force to a surface of a region ranging from the periphery of the convex structure to the vicinity of an inclined part of the convex structure and is not applied the liquid crystal alignment regulation force to a surface of the inclined part of the convex structure.

### CLAIM OF PRIORITY

The present application claims priority from Japanese patent application JP 2013-144386 filed on Jul. 10, 2013 the content of which is hereby incorporated by reference into this application.

### BACKGROUND OF THE INVENTION

1. Field of the Invention

The present invention relates to a liquid crystal display device configured to suppress occurrence of light leakage caused by alignment disorder of a liquid crystal in the vicinity of an alignment film formed on a convex structure, a manufacturing method for the liquid crystal display device and a liquid crystal alignment regulation force decision method for the liquid crystal display device.

2. Description of the Related Art

The scope of application of the liquid crystal display device is being expanded owing to its own features such as high display quality, thinness, light-weight, low power consumption and so forth and the liquid crystal display device is used in various applications ranging from mobile monitors such as a monitor for mobile phone, a monitor for digital still camera and so forth to monitors such as a monitor for desk top personal computer, monitors for use in printing and designing, a medical monitor and so forth and further to a liquid crystal TV and so forth. Attainment of higher image quality and higher quality of the liquid crystal display device is demanded with expanding the scope of application of the liquid crystal display device and attainment of higher luminance and lower power consumption which would be brought about by attainment of higher transmittance is eagerly demanded, in particular. In addition, cost saving is also eagerly demanded with spreading use of the liquid crystal display device.

In general, display is made on the liquid crystal display device in accordance with a change in optical characteristic of a liquid crystal layer occurring with a change in alignment direction of liquid crystal molecules which is induced by application of an electric field to the molecules in the liquid crystal layer interposed between one pair of substrates. The alignment direction of the liquid crystal molecules in no application of the electric field is defined by an alignment film prepared by performing a rubbing process on a surface of a polyimide thin film. In a currently available active drive type liquid crystal display device which is provided with a switching element such as a thin film transistor (TFT) and so forth per pixel, an electrode is provided on each of one pair of substrates which nip and hold the liquid crystal layer between them, a direction of the electric field to be applied to the liquid crystal layer is set so as to establish a so-called vertical electric field which is almost vertical to a substrate plane, and display is made by utilizing optical rotation of the liquid crystal molecule which configures the liquid crystal layer. As a typical liquid crystal display device of a vertical electric field system, a twisted nematic (TN: Twisted Nematic) system device, a vertical alignment (VA: Vertical Alignment) system device and so forth are known.

One of serious disadvantages of the TN system and VA system liquid crystal display devices is that the viewing angle is narrow. Therefore, as a display system which is configured to attain a wider viewing angle, an IPS (In-Plane Switching) system, an FFS (Fringe-Field Switching) system and so forth are known. The IPS system and the FFS system are display systems based on a so-called horizontal electric field system that a comb-like electrode is formed on one of one pair of substrates and the electric field generated has a component which is almost parallel with the substrate plane concerned and display is made by rotationally operating the liquid crystal molecules which configure the liquid crystal layer in a plane which is almost parallel with the substrate and utilizing birefringence of the liquid crystal layer. The IPS system and the FFS system have advantages such as wide viewing angle, low load capacity and so forth which are attained by in-plane switching of the liquid crystal molecules in comparison with the existing TN system, and the devices of the IPS system and FFS system are prospected as novel liquid crystal display devices which will supplant the device of the TN system and are now making rapid progress.

The liquid crystal display device controls an aligned state of the liquid crystal molecules in the liquid crystal layer in accordance with presence/absence of the electric field. That is, upper and lower polarizing plates which are provided outside of the liquid crystal layer are brought into a fully orthogonal state and a phase difference is caused to generate between the polarizing plates depending on the aligned state of the liquid crystal molecules interposed between the polarizing plates, thereby forming bright and dark states. Control of the aligned state of the liquid crystal molecules in a state of not applying the electric field to the liquid crystal is realized by forming a polymer thin film which is called an alignment film on a surface of the substrate and arraying the liquid crystal molecules in a direction that the polymer is arrayed by intermolecular interaction by Van der Waals force between a polymer chain and the liquid crystal molecules on the interface. This action is also called application of alignment regulation force or liquid crystal aligning property or alignment treatment.

A polyimide is frequently used in the alignment film of the liquid crystal display. In a method of forming the alignment film, polyamide acid which is a precursor of the polyimide is dissolved in various solvents and is applied onto the substrate by spin coating or printing, and then the substrate is heated at a high temperature of at least about 200° C. so as to remove the solvents and to imidize and cyclize the polyimide to a polyimide. A film thickness attained in the above-mentioned situation is as thin as about 100 nm. The surface of the polyimide thin film is rubbed with rubbing cloth in a fixed direction to align the polyimide polymer chains on the surface of the polyimide thin film in the above-mentioned direction, thereby realizing a state that anisotropy of the polymer on the thin film surface is high. However, the above mentioned-method has such disadvantages as generation of static electricity and foreign matters caused by rubbing, non-uniformity in rubbing caused by unevenness on the substrate surface and so forth. Therefore, a photo-alignment method of controlling alignment of molecules by using polarized light with no necessity of contact with the rubbing cloth is being gradually adopted.

Although, as the photo-alignment method for the liquid crystal alignment film, a photo-isomerization type method that intramolecular geometry is changed by being irradiated with polarized ultraviolet rays just like an azo dye, a photo-dimerization type method that chemical bonding of mutual backbones of molecules of cinnamic acid, coumarin, chalcone and so forth is caused to occur with polarized ultraviolet rays and other methods are available, a photodecomposition type method that only polymer chains which are arrayed in a polarization direction are cleaved by irradiating the polymer with polarized ultraviolet rays and polymer chains which are arrayed in a direction vertical to the polarization direction are made to stay behind is suitable for photo-alignment of the polyimide which is reliable and proven as the material of the liquid crystal alignment film.

Although such photo-alignment methods as mentioned above have been studied by using various liquid crystal display systems, a device which has adopted the IPS system in the above-mentioned systems is disclosed in Japanese Patent Application Laid-Open No. 2004-206091 as a liquid crystal display device which is reduced in generation of display defects caused by a fluctuation in the initial alignment direction, is stable liquid crystal alignment, is high in mass productivity and displays an image of high-grade quality which is increased in contrast ratio. Japanese Patent Application Laid-Open No. 2004-206091 indicates that property of controlling the alignment is afforded by the alignment treatment that in secondary treatment such as heating treatment, infrared irradiation treatment, far infrared irradiation treatment, electron beam irradiation treatment and radiation exposure treatment, at least one type of secondary treatment is performed on polyamic acid or a polyimide consisting of cyclobutanetetracarboxylic dianhydride and/or a derivative thereof and aromatic diamine.

In addition, it is also indicated, in particular, that the invention more effectively works by performing at least one type of treatment in the heating treatment, the infrared irradiation treatment, the far infrared irradiation treatment, the electron beam irradiation treatment and the radiation exposure treatment on the polyamic acid or the polyimide so as to overlap with polarized light irradiation treatment in time and the invention works more effectively also by performing baking treatment for imidization on an alignment control film so as to overlap with the polarized light irradiation treatment in time. It is further indicated that, in particular, when at least one type of treatment in the heating treatment, the infrared irradiation treatment, the far infrared irradiation treatment, the electron beam irradiation treatment and the radiation exposure treatment is to be performed on the liquid crystal alignment film in addition to the polarized light irradiation treatment, it is desirable that the temperature of the alignment control film be within a range from about 100° C. to about 400° C., more preferably, within a range from about 150° C. to about 300° C., and it is also possible and effective to use the heating treatment, the infrared irradiation treatment and/or the far infrared irradiation treatment together with the baking treatment for imidization to be performed on the alignment control film.

However, the above-mentioned liquid crystal display devices using the photo-alignment films are short in development history in comparison with a case where the rubbing alignment film has been used and there is no sufficient knowledge with respect to long-lasting display quality over several years or more as a liquid crystal display device to be practically used. That is, the present state is such that almost nothing is informed of with respect to a relation between the image quality defect which is not apparent at an early stage of manufacture and a disadvantage peculiar to the photo-alignment film.

In such a liquid crystal display device, a structure which is called a spacer is introduced into the liquid crystal layer in order to maintain the thickness of the liquid crystal layer interposed between one pair of substrates constant. Although polymer particles have been mixed into the liquid crystal so far in order to maintain the thickness of the liquid crystal layer constant as disclosed, for example, in Japanese Patent Application Laid-Open No. 2012-168474, nowadays, a method of forming a convex structure which is called a columnar spacer on the surface of one substrate is also used in some cases as disclosed, for example, in Japanese Patent Application Laid-Open No. 2011-186279. Since a particulate spacer is dispersed in the liquid crystal, the particulate spacer is also present in a liquid crystal display pixel, and therefore a technique of performing surface treatment on the surface of the substrate using alkylsilane and so forth such that alignment regulation force on the particle interface is reduced and the alignment regulation force only on the alignment film mainly works is adopted in order to control light scattering caused by liquid crystal alignment disorder on the particle interface. On the other hand, when the columnar spacer is used, such a pixel structure is designed that the columnar spacers are arranged at positions of, for example, a wiring electrode, a black matrix and so forth other than a pixel region such that alignment disorder which would occur on an interface between the above-mentioned elements may not adversely affect the display.

In addition, as described, for example, in Japanese Patent Application Laid-Open No. Hei8-313923, in a wall electrode type liquid crystal display element that display is made by filling a space between perpendicular pixel electrodes with the liquid crystal, it is important to control the liquid crystal alignment on a flat part between the wall electrodes and surfaces of the wall electrodes.

### SUMMARY OF THE INVENTION

In the liquid crystal display device that the convex structure is formed on the substrate surface, it is important to control the alignment on the surface of the convex structure in order to realize a liquid crystal display device having higher quality and higher definition. In particular, in recent years, the pixel itself has been more miniaturized, the aperture ratio of a display region in the pixel has been increased and a non-display region in which the columnar spacer would be possibly installed has been relatively narrowed as the definition of the liquid crystal display device is increased. Therefore the adverse effect of the liquid crystal disorder on the periphery of the columnar spacer which has not caused a disadvantage so far on the display quality may be feared. In addition, it becomes difficult to apply sufficient alignment regulation force by an existing rubbing method due to roughness on the surface of the substrate as the pixel is more miniaturized and uniform alignment may not be probably obtained due to the disorder of liquid crystal alignment in the vicinity of the wall electrode. Uniform alignment is made possible by the photo-alignment method in comparison with the rubbing method by which it is difficult to cope with roughness on the surface of the substrate. However, if miniaturization of the pixel is further promoted, the alignment disorder will probably occur on a side wall slope of the rough part even when the photo-alignment method is used.

The present invention aims to provide a liquid crystal display device capable of making display with high definition and high quality even when the pixel has been more miniaturized and the aperture ratio of the display region thereof has been more increased, a manufacturing method for the liquid crystal display device and a liquid crystal alignment regulation force decision method for evaluating the quality of the alignment film over the entire surface of a panel of a photo-alignment type liquid crystal alignment film which is suited for the liquid crystal display device.

According to an embodiment of the present invention, there is provided a liquid crystal display device including a TFT substrate that an alignment film is formed on a pixel including a pixel electrode and a TFT, a counter substrate which is arranged so as to face the TFT substrate and on the TFT substrate side of which an alignment film is formed and a liquid crystal which is interposed and held between the alignment film of the TFT substrate and the alignment film of the counter substrate, wherein

the alignment film is made of a material capable of applying liquid crystal alignment regulation force by polarized light irradiation,

a convex structure is formed on the TFT substrate or the counter substrate, and

the alignment film is coated using the alignment film material with which although the liquid crystal alignment regulation force is applied to a surface of a region ranging from the periphery of the convex structure to the vicinity to an inclined part of the convex structure, the liquid crystal alignment regulation force is not applied to a surface of the inclined part of the convex structure.

In the liquid crystal display device, an inclination angle of the convex structure is larger than about 85 degrees.

In the liquid crystal display device, the convex structure is a spacer adapted to maintain a distance between the TFT substrate and the counter substrate constant.

The liquid crystal display device is a liquid crystal display device of the IPS system.

In the liquid crystal display device, the liquid crystal display device of the IPS system includes a wall-type pixel electrode and the convex structure is the wall-type pixel electrode of the ISP system.

In the liquid crystal display device, the alignment film is a photodecomposition type photo-alignment film.

In the liquid crystal display device, the alignment film is a photodecomposition type photo-alignment film which contains a polyimide including a cyclobutane ring.

According to an embodiment of the present invention, there is provided a liquid crystal alignment regulation force decision method for a liquid crystal display device including a TFT substrate that an alignment film is formed on a pixel including a pixel electrode and a TFT, a counter substrate which is arranged so as to face the TFT substrate and on the TFT substrate side of which an alignment film is formed and a liquid crystal which is interposed and held between the alignment film of the TFT substrate and the alignment film of the counter substrate, wherein the alignment film is made of a photodecomposition type material capable of applying liquid crystal alignment regulation force by polarized light irradiation and a convex structure is formed on the TFT substrate or the counter substrate, including

the irradiation step of irradiating the alignment film formed on the convex structure with ultraviolet rays,

the dyeing step of dyeing the alignment film so irradiated with ultraviolet rays with a thiol derivative and

the decision step of deciding presence/absence of the liquid crystal alignment regulation force from a fluorescence distribution in the dyed alignment film.

According to an embodiment of the present invention, there is provided a manufacturing method for a liquid crystal display device which includes a TFT substrate that an alignment film is formed on a pixel including a pixel electrode and a TFT, a counter substrate which is arranged so as to face the TFT substrate and on the TFT substrate side of which an alignment film is formed and a liquid crystal which is interposed and held between the alignment film of the TFT substrate and the alignment film of the counter substrate, wherein the alignment film is made of a material capable of applying liquid crystal alignment regulation force by polarized light irradiation and a convex structure is formed on the TFT substrate or the counter substrate, including

the alignment film formation process of forming the alignment film on the convex structure and thereafter

the photo-alignment process of photo-aligning the alignment film by irradiating a surface of the substrate on which the alignment film is formed with polarized light which is collimated from a vertical direction.

Here, in the liquid crystal display device which includes the TFT substrate that the alignment film is formed on the pixel which includes the pixel electrode and the TFT, the counter electrode which is arranged so as to face the TFT substrate and the TFT substrate side of which the alignment film is formed and the liquid crystal which is interposed and held between the alignment film of the TFT substrate and the alignment film of the counter substrate, the convex structure means a structure which is projected from at least one of the respective substrates into the liquid crystal layer relative to a level line which connects together the surfaces of the alignment films present in a display region and in which the alignment film is at least partially coated also onto the surface of the convex structure. As examples of the convex structure, the columnar spacer adapted to maintain the distance between the TFT substrate and the counter substrate of the liquid crystal display device constant, the wall type pixel electrode adapted to apply a specific liquid crystal drive voltage, the black matrix which is provided for improving the contrast of the liquid crystal display device, the wiring electrode which is provided in a part other than the display region, a bank structure which is provided in order to secure film thickness uniformity when coating and depositing the alignment film and so forth may be given. With respect to the point that to what extent a structure is to be projected so as to be defined as the convex structure, a structure which is projected beyond the level line by a height corresponding to at least about 10% of the film thickness of the alignment film which is present at least in the display region is defined as the convex structure.

In addition, the inclined part of the convex structure means an outer peripheral region of the convex structure which is lower than the level position of the top of the convex structure and reaches a height lower than the level line which connects together the surfaces of the alignment films and, in particular, a part which is close to the display region.

In addition, the angle of inclination of the convex structure means an angle made by a surface of a ground layer on which the convex structure is formed and a central tangential line of the inclined part when viewed from a direction of the section thereof.

In addition, here, the polyimide is a polymer compound expressed by [Chemical Formula 1] where a structure in square brackets [ ] indicates a chemical structure of a repeating unit, a subscript n indicates the number of repeating units, N is a nitrogen atom, O is an oxygen atom, A is a quadrivalent organic group, and D is a bivalent organic group. As examples of the structure of A, aromatic cyclic compounds such as a phenylene ring, a naphthalin ring, an anthracene ring and so forth, aliphatic cyclic compounds such as a cyclobutane ring, cyclopentane ring, cyclohexane ring and so forth and/or compounds and so forth each formed by combining one of the above-mentioned compounds with a substituent may be given. In addition, as examples of the structure of D, aromatic cyclic compounds such as the phenylene ring, a biphenylene ring, an oxybiphenylene ring, a biphenyleneamine ring, the naphthalin ring, the anthracene ring and so forth, aliphatic cyclic compounds such as a cyclohexen ring, a bicyclohexen ring and so forth and/or compounds and so forth each formed by combining one of the above-mentioned compounds with a substituent may be given.

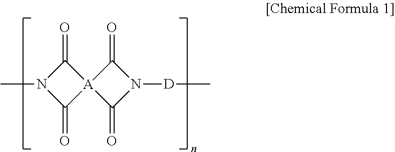

These polyimides are coated on various ground layers which are held on the substrate in the state of precursors of the polyimides.

In addition, here, the precursor of the polyimide means polyamide acid or a polyamide acid ester polymer compound expressed by [Chemical Formula 2]. Here, H is a hydrogen atom, R₁ and R₂ are hydrogen or alkyl chains of —CₘH₂ₘ₊₁ (m=1 or 2).

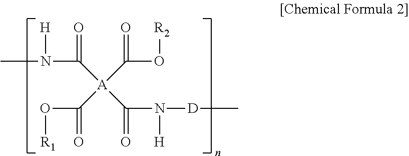

In order to form such an alignment film, in a general polyimide alignment film forming process, for example, after the ground layer has been cleaned by using various surface treatment processes such as a UV/ozone cleaning process, an excimer UV cleaning process, an oxygen plasma cleaning process and so forth, the precursor of the alignment film is coated by using various printing processes such as a screen printing process, a flexographic printing process, an ink-jet printing process and so forth and such levelling treatment that a uniform film thickness is obtained is performed under predetermined conditions, and thereafter a polyamide which is the precursor is subjected to imidization reaction so as to be converted into a polyimide by heating the polyamide at a temperature of, for example, at least about 180° C., thereby forming a thin film. Further, generation of alignment regulation force on a surface of the polyimide alignment film is made possible by irradiating the polyimide alignment film with polarized ultraviolet rays by using desired measures. Two upper and lower substrates equipped with the alignment films so formed are bonded together by retaining a predetermined space between the substrates, the space so retained is filled with a liquid crystal and ends of the substrates are sealed together, thereby completing formation of a liquid crystal panel. Optical films such as polarizing plates, phase difference plates and so forth are bonded to the panel and a drive circuit, a backlight and so forth are put on the panel, thereby obtaining the liquid crystal display device.

According to the embodiments of the present invention, it is possible to provide the high definition and high quality liquid crystal display device, the manufacturing method for the liquid crystal display device and the liquid crystal alignment regulation force decision method of evaluating the quality of the alignment film over the entire surface of the panel of the photo-alignment type liquid crystal alignment film suitable for the liquid crystal display device even when the pixel has been more miniaturized and the aperture ratio of the display region of the pixel has been increased.

### BRIEF DESCRIPTION OF THE DRAWINGS

FIG. 1A is a schematic diagram illustrating one structural example of a convex structure and an alignment film of a liquid crystal display device according to an embodiment of the present invention.

FIG. 1B is a schematic diagram illustrating one structural example of the convex structure and the alignment film of the liquid crystal display device according to the embodiment of the present invention.

FIG. 1C is a schematic diagram illustrating one structural example of the convex structure and the alignment film of the liquid crystal display device according to the embodiment of the present invention.

FIGS. 2A-2D are schematic diagrams illustrating examples of the convex structure, the alignment film and photo-alignment of the liquid crystal display device according to the embodiment of the present invention, in which FIG. 2A is one example of a case where a side face of the convex structure is tapered, FIG. 2B is one example of a case where the side face of the convex structure is vertical, FIG. 2C is one example of a case where the side face of the convex structure is vertical and a root part thereof has a hollow and FIG. 2D is one example of a case where the side face of the convex structure is vertical and the root part thereof is inversely tapered.

FIGS. 3A-3D are schematic diagrams illustrating examples of the convex structure, the alignment film and photo-alignment of the liquid crystal display device according to the embodiment of the present invention, in which FIG. 3A is one example of a case where the side face of the convex structure is tapered and ultraviolet ray irradiation has been vertically performed, FIG. 3B is one example of a case where the side face of the convex structure is tapered and ultraviolet ray irradiation has been obliquely performed, FIG. 3C is one example of a case where the side face of the convex structure is vertical and ultraviolet ray irradiation has been obliquely performed and FIG. 3D is one example of a case where the side face of the convex structure is vertical and ultraviolet ray irradiation has been vertically performed.

FIG. 4 is a diagram illustrating one example of a photo-alignment device adapted to produce the liquid crystal display device according to the embodiment of the present invention.

FIGS. 5A and 5B are explanatory diagrams illustrating examples of collimating property of the photo-alignment device adapted to produce the liquid crystal display device according to the embodiment of the present invention, in which FIG. 5A is a diagram illustrating one example of the photo-alignment device viewed from a y-axis direction and FIG. 5B is a diagram illustrating one example of the photo-alignment device viewed from an x-axis direction.

FIG. 6 is an explanatory diagram illustrating one example of a method of confirming presence/absence of alignment regulation force on the alignment film of the liquid crystal display device according to the embodiment of the present invention.

FIG. 7A is a schematic block diagram illustrating one example of a schematic configuration of the liquid crystal display device according to the embodiment of the present invention.

FIG. 7B is a schematic circuit diagram illustrating one example of a circuit configuration of one pixel of a liquid crystal display panel illustrated in FIG. 7A.

FIG. 7C is a schematic plan view illustrating one example of a schematic configuration of the liquid crystal display panel illustrated in FIG. 7A.

FIG. 7D is a schematic sectional diagram illustrating one example of a sectional configuration along the A-A′ line in FIG. 7C.

FIG. 8 is a schematic diagram illustrating one example of a schematic configuration of an IPS system liquid crystal display panel according to an embodiment of the present invention.

FIG. 9 is a schematic diagram illustrating one example of a schematic configuration of an FFS system liquid crystal display panel according to an embodiment of the present invention.

FIG. 10 is a schematic diagram illustrating one example of a schematic configuration of a VA system liquid crystal display panel according to an embodiment of the present invention.

FIG. 11 is a schematic diagram illustrating one example of a substrate for evaluation used in a liquid crystal alignment regulation force decision method according to an embodiment 1 of the present invention.

FIG. 12 is a partial schematic plan view illustrating one example of a liquid crystal display device for evaluation used in a liquid crystal alignment regulation force decision method according to an embodiment 4 of the present invention.

FIGS. 13A and 13B are schematic diagrams of a columnar spacer in the liquid crystal display device for evaluation used in the liquid crystal alignment regulation force decision method according to the embodiment 4 of the present invention, in which FIG. 13A is a bird's-eye view and FIG. 13B is a sectional diagram.

### DETAILED DESCRIPTION OF THE PREFERRED EMBODIMENTS

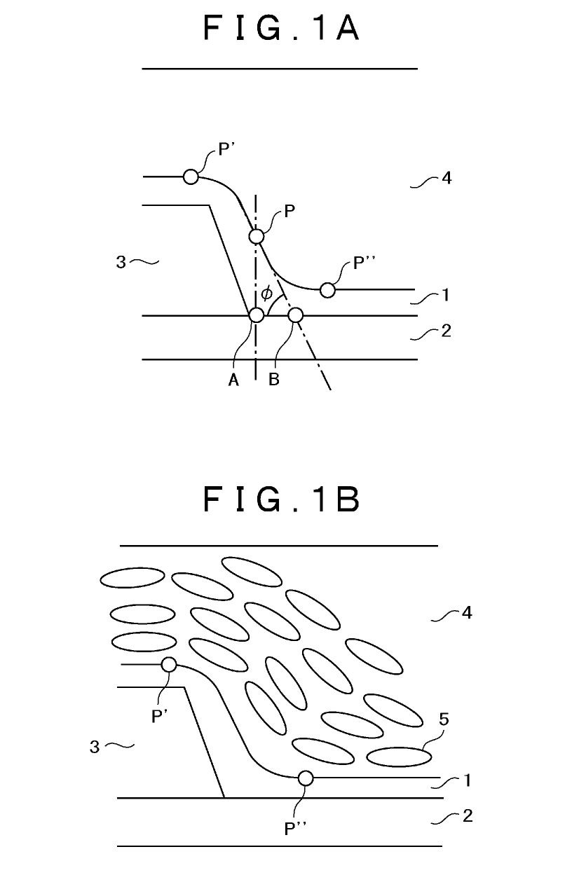

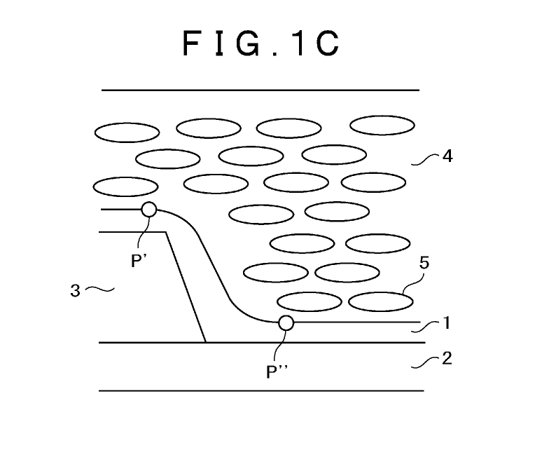

In the following, the present invention will be described in detail together with preferred embodiments with reference to the accompanying drawings. Incidentally, in all drawings for illustrating the embodiments of the present invention, the same numerals are assigned to element having the same functions and repetitive description thereof is omitted. FIG. 1A illustrates one example of a sectional structure of an alignment film under which a convex structure is formed and a peripheral part of the convex structure. An alignment film 1 is formed on a ground layer 2 and a convex structure (for example, a columnar spacer) 3 and a liquid crystal layer 4 is formed on the alignment film 1. An inclined part of the alignment film 1 means an alignment film surface part ranging from a point P′ on an end of a flat part thereof situated on the convex structure 3 to a point P″ at which influence of the convex structure 3 is eliminated. An inclination angle φ of the inclined part of the alignment film 1 is defined as an angle ∠PBA formed by connecting a point P having an intermediate height between heights of the point P′ and the point P″ when viewed in a film thickness direction, a point B at which a tangential line extending from the point P on the surface of the alignment film 1 intersects with the surface of the ground layer 2 and a point A at which a perpendicular line extending from the point P down to the ground layer 2 intersects with the surface of the ground layer 2 in this order. In addition, although not illustrated in the drawings in particular, a pixel part of a liquid crystal display device according to an embodiment of the present invention is present on an outer part of the inclined part of the alignment film 1.

When alignment regulation force is caused to generate on the surface of the alignment film 1 so formed by polarized ultraviolet ray irradiation, anisotropy occurs in arrangement of an alignment film molecule chain and a lateral substituent on the alignment film 1 surface and therefore the alignment of the liquid crystal molecules which are present on the alignment film 1 in contact with the alignment film 1 is controlled. Here, FIG. 1B illustrates one example of a case where the similar alignment regulation force has been applied to the section between the points P′ and P″ on the alignment film surface on the periphery of the convex structure 3 and FIG. 1C illustrates one example of a case where the above-mentioned section has no alignment regulation force. Incidentally, reference numeral 5 denotes a liquid crystal molecule. The embodiment of the present invention embodies such an alignment film structure that the alignment regulation force is not generated on the periphery of the convex structure 3 as illustrated in FIG. 1C. Here, when the alignment regulation force is also applied to the section between the points P′ and P″ on the alignment film surface on the periphery of the convex structure 3, alignment regulation force which works in parallel with the inclined plane of the structure is generated and therefore liquid crystal alignment occurs in a direction different from that of the alignment of a flat part other than the above and alignment disorder occurs in the vicinity of the inclined plane. Since, in general, a liquid crystal cell has a structure that a liquid crystal layer is interposed between the alignment films which have been subjected to alignment treatment in parallel with the surfaces of the upper and lower substrates leaving a space of about several μm, the alignment regulation force affects over a distance of at least about several μm or more. On the other hand, when the alignment regulation force is not present on that part, alignment of the flat part other than the above works predominantly and the alignment disorder does not occur up to the inclined part of the convex structure 3. The influence of the liquid crystal alignment disorder in the vicinity of the inclined part on the periphery of the convex structure 3 is increased as the definition of the liquid crystal display device is increased and the pixel size is decreased. That is, since it is difficult to uniformly apply the alignment regulation force onto the peripheral part of such an unevenly formed part, it is a region where alignment disorder is liable to occur.

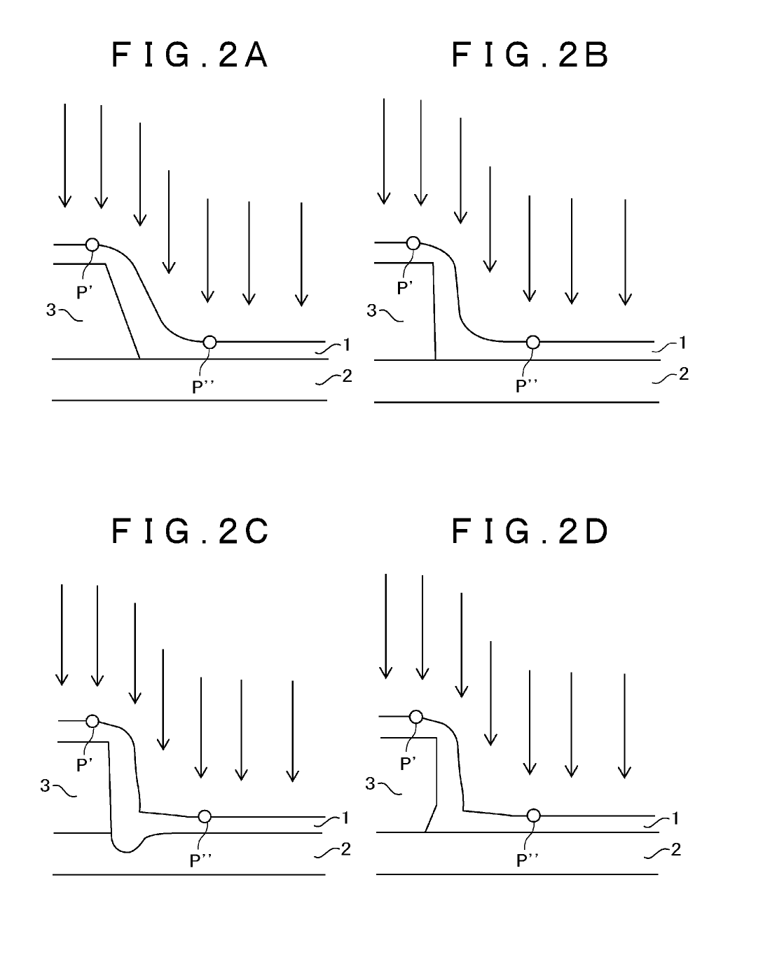

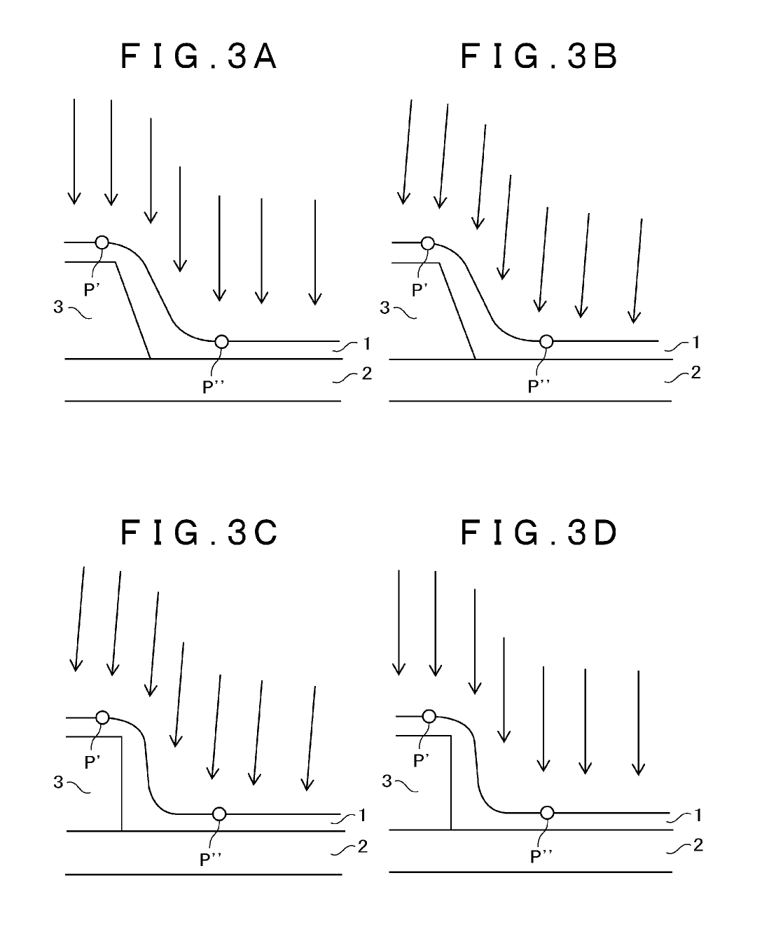

FIG. 2A schematically illustrates one example of the influence of the inclination angle of the peripheral part of the convex structure 3 when the alignment film surface is to be irradiated with polarized ultraviolet rays. In general, the substrate surface is vertically (a direction of arrows in the drawing) irradiated with the polarized ultraviolet rays and therefore the flat part is also vertically irradiated with the polarized ultraviolet rays. However, since the peripheral part of the convex structure 3 has a fixed inclination angle, the surface of the peripheral part is obliquely irradiated with the polarized ultraviolet rays. Here, assuming that I₁ is a light intensity of the original polarized ultraviolet rays per unit area, a light intensity per unit area at the inclination angle φ will be given by I₀×cos² φ. That is, the light intensity per unit area approaches zero as the inclination angle φ approaches 90°. Therefore, when the inclination angle of the peripheral part of the convex structure 3 is set to about 90°, for example, as illustrated in FIG. 2B, also the inclination angle of the alignment film 1 coated onto the convex structure 3 more approaches 90° and it becomes possible to reduce a region to be obliquely irradiated with the polarized ultraviolet rays. Further, it is also possible to make steep a bend angle in the lower vicinity on the periphery of the convex structure 3, in particular, when the alignment film has been coated thereon by providing a recessed part (a hollow) in the ground layer on the periphery of the root of the convex structure 3 as illustrated in FIG. 2C or by providing a recessed part (or a slightly inversely tapered form) in the root of the convex structure 3 as illustrated in FIG. 2D. To make steep the bend angle in this way contributes to exerting the influence of the alignment of the flat part onto the extreme vicinity of the inclined part of the convex structure 3. A structure that the bend angle formed on an upper part of the convex structure 3 is made steep also contributes to exerting the influence of the alignment of the upper flat part onto the extreme vicinity of the inclined part of the convex structure 3 similarly. Considering from the above-mentioned points, the more the line segment between the points P′ and P″ runs in parallel with the tangential line at the point P, the more the convex structure 3 is made desirable.

The alternative view is that an inclination angle of such an extent that total reflection on the alignment film surface is met is sufficient to suppress oblique irradiation of the inclined part of the convex structure 3 with ultraviolet rays. For example, if a refractive index of the alignment film 1 is 1.5, an angle of total reflection from an air space will be arcsin(1/1.5)=0.73 rad=42°. However, since pervasion of light on the order of the light wavelength occurs in a thin film even when an incident angle of ultraviolet rays onto the alignment film surface is smaller than the total reflection angle, it is difficult for the alignment film 1 of a film thickness of about 100 nm at most to fully prevent intrusion of the ultraviolet rays and consequently light-dependent alignment regulation force is generated even when the incidence angle of the ultraviolet rays is smaller than the total reflection angle. It is necessary to make the incidence angle of the ultraviolet rays onto the alignment film surface smaller than the total reflection angle as described in the following embodiments in order to effectively prevent oblique intrusion of the ultraviolet rays.

Such oblique irradiation of the inclined part on the periphery of the convex structure with ultraviolet rays also occurs under the influence of light beam linearity of a light source of the ultraviolet rays for irradiation. That is, in case of light constituted of only light beams traveling in a direction vertical to the substrate surface as illustrated in FIG. 3A, only the inclined part on the periphery of the convex structure is a region to be influenced by obliquely irradiated light. While, when ultraviolet light beams to be irradiated include components which are oblique relative to the vertical direction as illustrated in FIG. 3B, the entire surface of the alignment film 1 is irradiated with ultraviolet rays which are obliquely incident and the inclined part of the convex structure may be irradiated with the ultraviolet rays at an angle which is nearly vertical to the inclined plane of the inclined part in some cases and thus the alignment disorder on the peripheral part of the convex structure 3 may be more increased. Such a difference between light beams from the light source is also observed even when the inclination angle of the convex structure 3 is small as illustrated in FIG. 3C and FIG. 3D. That is, the method described hereinabove is an alignment regulation force application method which becomes feasible for the first time by adjusting both of the structure on the alignment film side to be irradiated with the ultraviolet rays and the structure of the light source of the ultraviolet rays for irradiation.

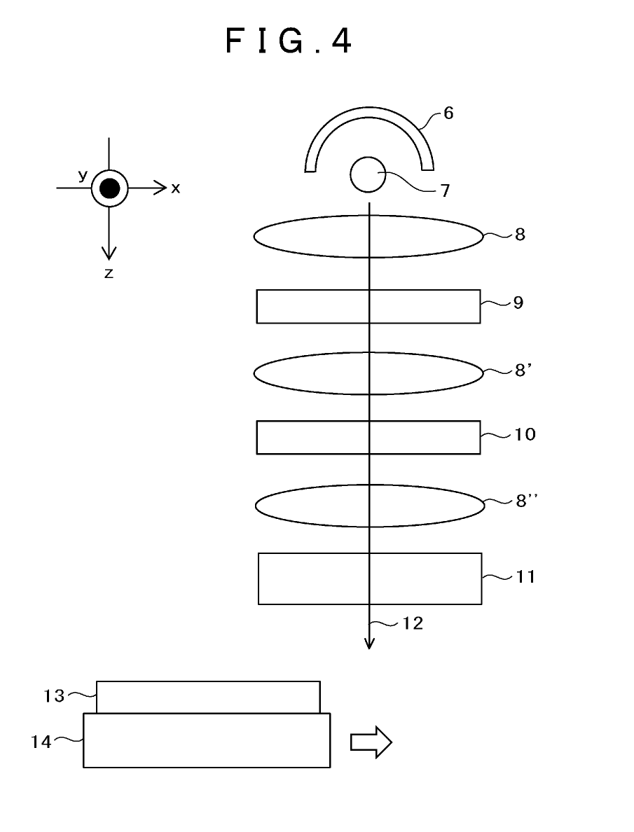

FIG. 4 illustrates one example of an optical system for polarized ultraviolet ray irradiation which is suitable for formation of an alignment film material with which although the liquid crystal alignment regulation force is applied up to the vicinity of the inclined part of the structure according to the present embodiment, almost no alignment regulation force is applied to the inclined part of the convex structure 3. Although it is desirable to irradiate the alignment film with polarized ultraviolet rays uniformly over the widest possible area for application of such alignment regulation force, it is necessary to adjust the optical system so as not to obliquely irradiate the surface of the alignment film 1 with the ultraviolet rays at the same time and it is possible to increase the collimating property of the polarized ultraviolet rays by using well known measures for this purpose.

Here, a top-down direction (a direction vertical to the substrate plane) on a paper plane is referred to as a z-axis direction, a right-left direction is referred to as an x-axis direction in which the substrate plane is scanned and is irradiated with the ultraviolet rays and a direction vertical to the paper plane is referred to as a y-axis direction. The optical system includes an ultraviolet light source 7 and a reflecting mirror 6 adapted to guide the light irradiated onto the back face side thereof to the opposite side and the ultraviolet rays are guided downward from, for example, a horizontal plane with the aid of the light source 7 and the reflecting mirror 6. Although it is possible to collect the light by imparting directivity in the z-axis direction to some extent at this stage, it is difficult to fully collimate the light in that direction. The light passes through a succeeding optical path adjustment optical system 8 (including optical components such as, for example, a lens and a mirror which have been optically designed appropriately and a mask and so forth for intercepting excessive diffused-light components) and is guided to a succeeding y-axis prism array 9 from an optimum direction while avoiding diffusion of the light to the greatest possible extent, thereby increasing the collimating property of the light which is diffused in the y-axis direction. Next, the light is guided to a succeeding x-axis prism array 10 in an optimum direction, passing through another optical path adjustment optical system 8′, thereby increasing the collimating property of the light which is diffused in the x-axis direction. The light passes through still another optical path adjustment optical system 8″, then passes through a polarizer 11 which is adapted to convert the light into light which is polarized in a specific direction (for example, the y-axis direction) and is radiated in the z-axis direction in the form of a polarized ultraviolet ray 12 which is high in collimating property. A substrate transport mechanism 14 on which a substrate 13 equipped with the alignment film is loaded moves under the polarizer 11, for example, in the x-axis direction while maintaining horizontality. Thus, the entire surface of the substrate 13 on the uppermost layer of which the alignment film is attached is uniformly irradiated with the polarized ultraviolet ray which is high in collimating property and as a result of which it becomes possible to apply the alignment regulation force onto the surface of the substrate 13. Although not illustrated in particular in the drawings, it is also possible to use a selective wavelength filter for the purpose of utilizing only light having a specific wavelength from the primary ultraviolet light source 7 depending on individual object. In addition, when an alignment film material with which the alignment property is imparted with light having a wavelength other than that of the ultraviolet ray depending on the objective alignment film is to be used, it is also possible to use a light source including light of a wavelength which is suitable for the material.

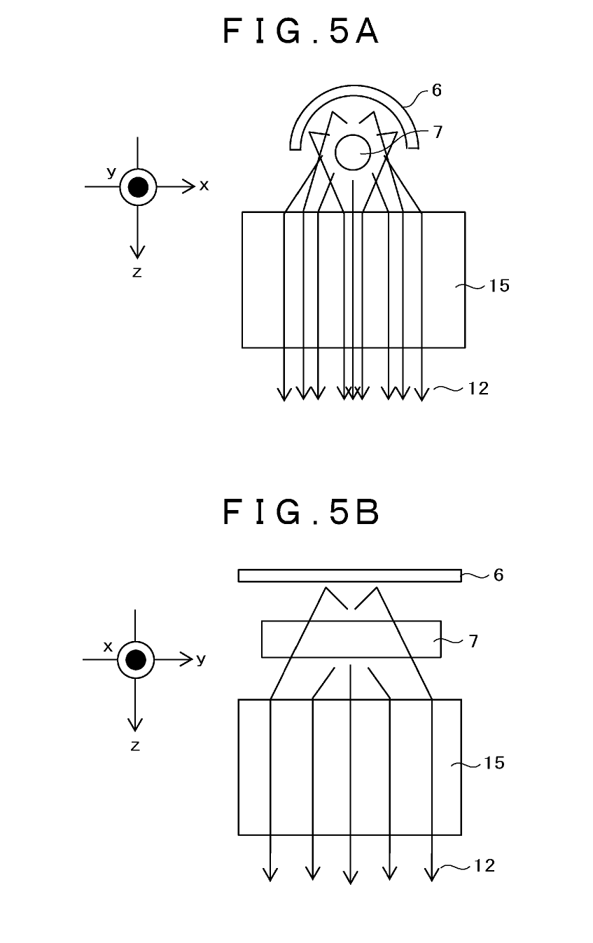

FIG. 5A and FIG. 5B are explanatory diagrams illustrating examples of biaxial collimating property when the ultraviolet light source is of a liner type. Such severally illustrated optical components as those in FIG. 4 are not illustrated in FIGS. 5A and 5B, but are illustrated altogether as a collimation optical system 15. In addition, the linear type light source means a light source having a one-dimensional shape such as a so-called long-arc type ultraviolet lamp. Since the long-arc ultraviolet lamp has a shape extending in a one-dimensional direction, it is suited for collective irradiation over a wider area in comparison with a short-arc type ultraviolet lamp configured to symmetrically emit light from one point. Here, FIG. 5A and FIG. 5B illustrate diagrams viewed from two directions, that is, an x-z plane in FIG. 5A and a y-z plane in FIG. 5B, assuming that a one-dimensional light source extending in the y-axis direction is used. When the collimating property of light is considered only in one direction, it is not easy for even an optical system configured to adjust the optical path vertically in the z-axis direction when viewed, for example, in the x-z plane illustrated in FIG. 5A to inevitably attain the collimating property from the one-dimensional property of the light source relative to the y-z plane illustrated in FIG. 5B. Therefore, if the collimating property is attained in two directions as described with reference to FIG. 4, there will be obtained an optical system capable of adjusting the optical path vertically or in the z-axis direction also when viewed from the y-z plane illustrated in FIG. 5B. Such an optical system is an optical system which is also applicable when a planar ultraviolet light source which is not yet known so much at the present time will have been put into practical use in feature.

Specifically, as an evaluation method of evaluating to what extent the light emitted from a light source used is excellent in collimating property or is diffused, it is possible to use various existing evaluation methods. It is possible to perform evaluation, for example, by measuring dependency of a light intensity distribution in a sectional direction of the light beam on a distance from the light source. In particular, it is possible to evaluate whether a light source concerned is suitable for the present embodiment from dependency of a light intensity on an angle relative to the light beam from the light source by using a photo-sensor having a light receiving part area which is sufficiently small in comparison with a beam diameter, in addition to the point that the beam diameter of the entire light source is constant.

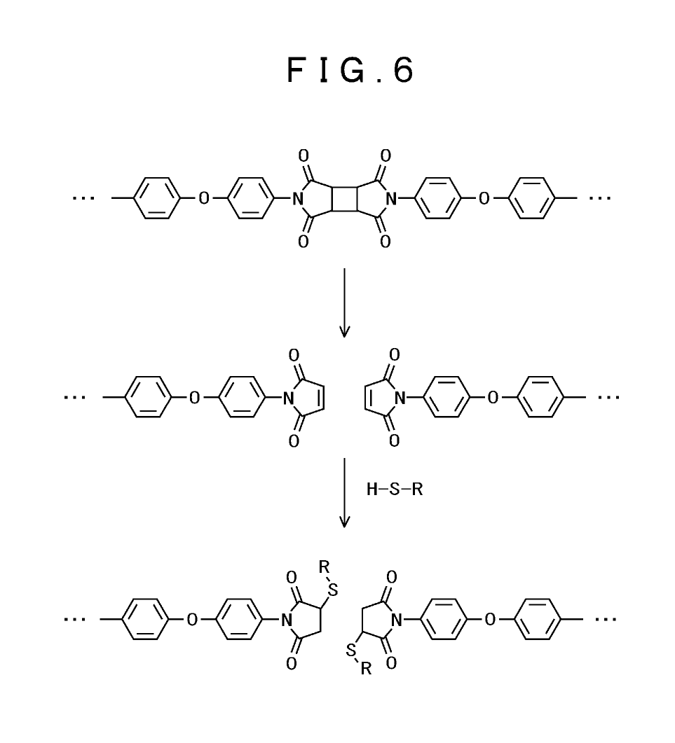

Next, one example of a technique of deciding whether the inclined part of the convex structure is photo-aligned will be given. When the liquid crystal alignment regulation force is present on the convex structure 3 as illustrated in FIG. 1, the effect of presence of the liquid crystal alignment regulation force is exhibited as a state that the force is causing liquid crystal alignment disorder in the display region. However, when light leakage occurs by being influenced by light scattering from the convex structure itself, it is difficult to discriminate whether the alignment disorder occurs by being influenced by the alignment regulation force on the alignment film surface. Thus, as a result of making a study of methods for discrimination as to the above-mentioned matter, the inventors and others of the present invention have found that it is possible to decide whether the alignment regulation force is generated on the alignment film surface on the inclined part of the convex structure 3 by such measures as described below. When the alignment film is made of a polyimide which includes a part that a cyclobutane ring, an amide ring and a phenylene ring are linked, for example, as illustrated in FIG. 6, the cyclobutane ring which is unstable in chemical structure is opened and a polyimide chain is cut off at that part by light absorption into the phenylene ring of about 200 nm to about 350 nm. At that time, although a meleimide backbone is generated on a terminal end, that part is dyed with a reagent which is liable to be selectively added to that part to add, for example, a thiol derivative H—S—R to that part. In this case, an alignment film surface that only the added part selectively fluoresces is obtained by selecting a chemical backbone which is high in fluorescent yield for a functional group R. It is possible to observe presence/absence of such fluorescence through a fluorescent microscope and so forth and, in particular, it is possible to detect whether the alignment film on the inclined part of the convex structure 3 fluoresces by obliquely irradiating the film with excitation light in a dark field observation mode and vertically observing florescence.

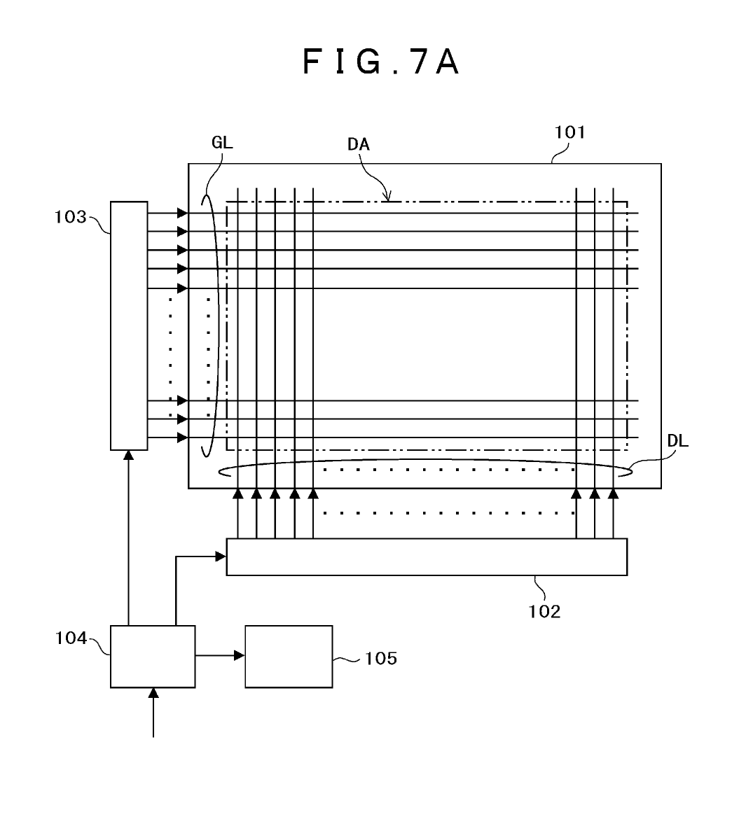

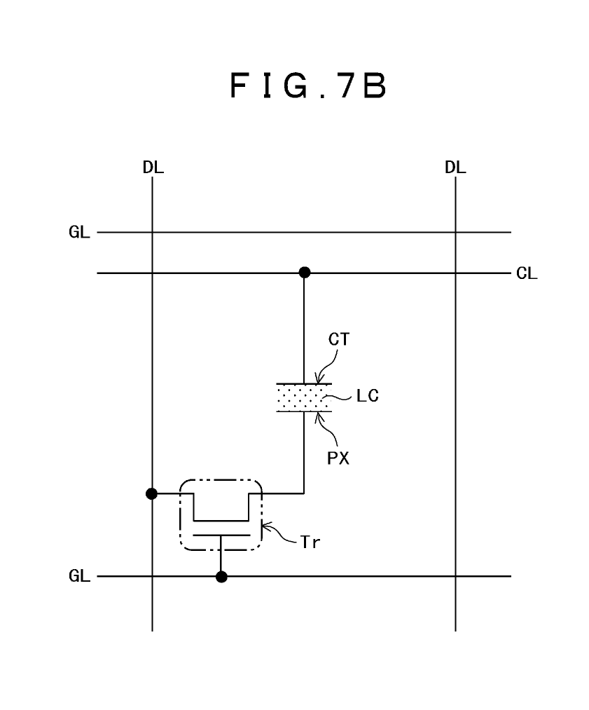

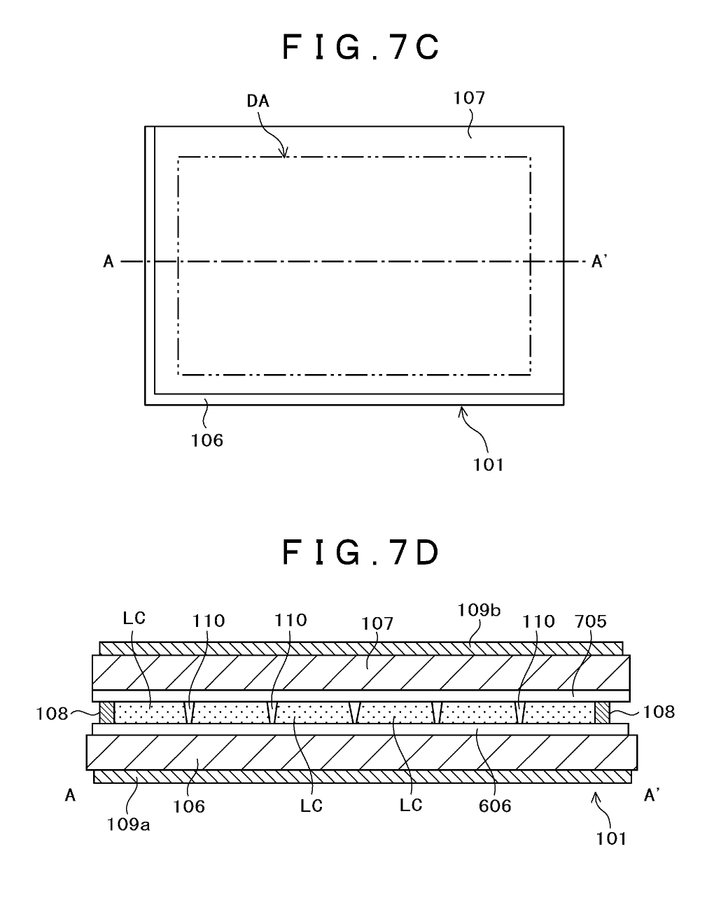

Next, the liquid crystal display device according to the present embodiment in which the alignment film is formed will be described. FIG. 7A to FIG. 7D are schematic diagrams illustrating examples of a schematic configuration of the liquid crystal display device according to the present embodiment. FIG. 7A is a schematic block diagram illustrating one example of a schematic configuration of the liquid crystal display device according to the present embodiment. FIG. 7B is a schematic circuit diagram illustrating one example of a circuit configuration of one pixel in a liquid crystal display panel illustrated in FIG. 7A. FIG. 7C is a schematic plan view illustrating one example of a schematic configuration of the liquid crystal display panel illustrated in FIG. 7A. FIG. 7D is a schematic sectional diagram illustrating one example of a sectional configuration along the A-A′ line in FIG. 7C.

The alignment film according to the present embodiment is applied to, for example, an active matrix system liquid crystal display device. The active matrix system liquid crystal display device is used, for example, in a display (a monitor) for mobile electronic equipment, a display for personal computer, displays for use in printing and designing, a display for medical equipment, a liquid crystal TV and so forth.

The active matrix system liquid crystal display device includes a liquid crystal display panel 101, a first drive circuit 102, a second drive circuit 103, a control circuit 104 and a backlight 105, for example, as illustrated in FIG. 7A.

The liquid crystal display panel 101 includes a plurality of scan signal lines GL (gate lines) and a plurality of video signal lines DL (drain lines). The video signal lines DL are connected to the first drive circuit 102 and the scan signal lines GL are connected to the second drive circuit 103. Incidentally, some of the plurality of scan signal lines GL are illustrated in FIG. 7A and a larger number of scan signal lines GL are densely arranged on the actual liquid crystal panel 101. Likewise, some of the plurality of video signal lines DL are illustrated in FIG. 7A and a larger number of video signal lines DL are densely arranged on the actual liquid crystal display panel 101.

In addition, a display region (area) DA of the liquid crystal display panel 101 is configured by an assembly of many pixels and a region that one pixel occupies in the display region DA corresponds to a region surrounded by, for example, the two adjacent scan signal lines GL and the two adjacent video signal lines DL. In this case, the circuit configuration of one pixel is configured, for example, as illustrated in FIG. 7B and includes a TFT element Tr which functions as an active element, a pixel electrode PX, a common electrode CT (sometimes called a counter electrode) and a liquid crystal layer LC. Also, in this case, the liquid crystal display panel 101 also includes a communization wiring CL which communizes the common electrodes CT of the plurality of pixels.

In addition, the liquid crystal display panel 101 has a structure that an alignment film 606 and an alignment film 706 are respectively formed on surfaces of an active matrix substrate 106 and a counter substrate 107 and the liquid crystal layer LC (the liquid crystal material) is interposed between the alignment films 606 and 705, for example, as illustrated in FIG. 7C and FIG. 7D. In addition, although not particularly illustrated in the drawings, intermediate layers (optical intermediate layers such as, for example, a phase difference plate, a color conversion layer, a light diffusion layer and so forth) may be provided between the alignment film 606 and the active matrix substrate 106 and/or between the alignment film 705 and the counter substrate 107.

In the above-mentioned case, the active matrix substrate 106 and the counter substrate 107 are adhered together with an annular seal material 108 provided on the outside of the display region DA and the liquid crystal layer LC is sealed in a space surrounded by the alignment film 606 on the active matrix substrate 106 side, the alignment film 705 on the counter substrate 107 side and the seal material 108. In addition, in this case, the liquid crystal display panel 101 of the liquid crystal display device which includes the backlight 105 includes one pair of polarizing plates 109a and 109b which are arranged so as to face each other with the active matrix substrate 106, the liquid crystal layer LC and the counter substrate 107 interposed.

Incidentally, the active matrix substrate 106 is a substrate that the scan signal lines GL, the video signal lines DL, the active element (the TFT element Tr), the pixel electrode PX and so forth are arranged on an insulating substrate such as a glass substrate and so forth. In addition, when a driving system of the liquid crystal display panel 101 is a horizontal electric field driving system such as the IPS system and so forth, the common electrode CT and the communization wiring CL are arranged on the active matrix substrate 106. In addition, when the driving system of the liquid crystal display panel 101 is a vertical electric field driving system such as the TN system, the VA (Vertically Alignment) system and so forth, the common electrode CT is arranged on the counter electrode 107. When the liquid crystal display panel 101 is of the vertical electric field driving system, the common electrode CT is generally one large-area plate electrode which is shared among all of the pixels and the communization wiring CL is not provided.

In addition, in the liquid crystal display device according to the present embodiment, a plurality of columnar spacers 110 adapted to make a thickness (sometimes called a cell gap) of the liquid crystal layer LC in each pixel uniform are provided in the space that the liquid crystal layer LC is sealed. The plurality of columnar spacers 110 are provided, for example, on the counter substrate 107.

The first drive circuit 102 is a drive circuit which is adapted to generate a video signal (sometimes called a gradation voltage) to be applied to the pixel electrode PX of each pixel via each video signal line DL and is generally called a source driver, a data driver and so forth. In addition, the second drive circuit 103 is a drive circuit which is adapted to generate a scan signal to be applied to the scan signal line GL and is generally called a gate driver, a scan driver and so forth. In addition, the control circuit 104 is a circuit which is adapted to control operations of the first drive circuit 102 and the second drive circuit 103 and to control the luminance of the backlight 105 and so forth and is a control circuit generally called a TFT controller, a timing controller and so forth. In addition, the backlight 105 is a light source such as, for example, a fluorescent light such as a cold cathode fluorescent light and so forth, a light emitting diode (LED) and so forth and light that the backlight 105 has emitted is converted into a planar light beam by not illustrated reflective plate, light guide plate, light diffusion plate, prism sheet and so forth and is irradiated onto the liquid crystal display panel 101.

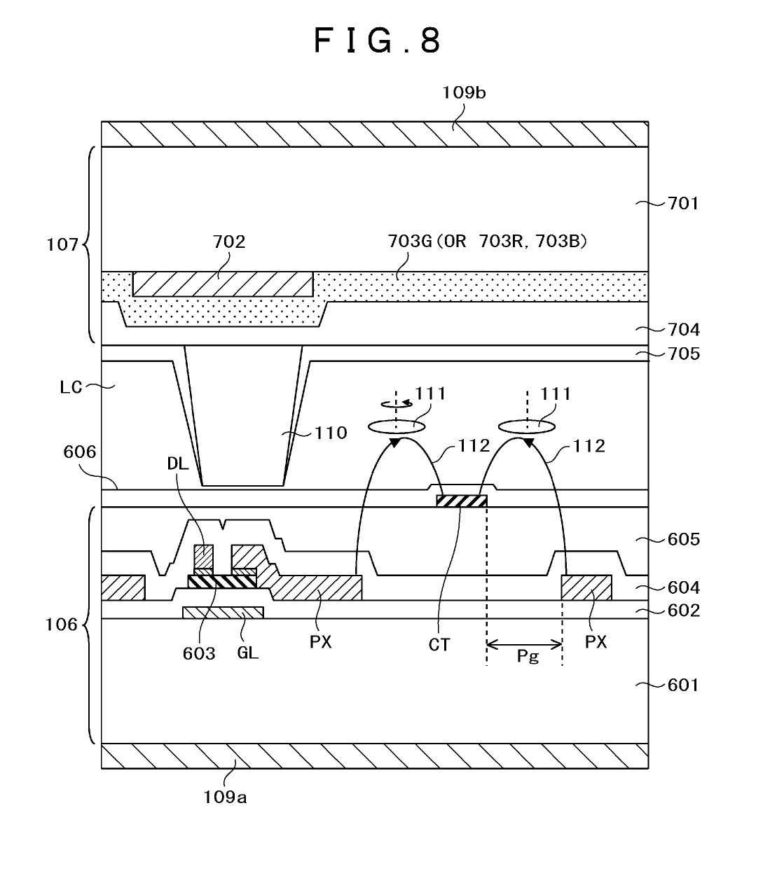

FIG. 8 is a schematic diagram illustrating one example of a schematic configuration of the IPS system liquid crystal display panel according to the present embodiment. In the active matrix substrate 106, the scan signal lines GL, the communization wiring CL, and a first insulation layer 602 which covers the above-mentioned elements are formed on a surface of an insulation substrate such as a glass substrate 601 or the like. A semiconductor layer 603 of the TFT element Tr, the video signal lines DL, the pixel electrode PX and a second insulation layer 604 which covers the above-mentioned elements are formed on the first insulation layer 602. The semiconductor layer 603 is arranged above the scan signal line GL and a part of the scan signal line GL which is situated under the semiconductor layer 603 functions as a gate electrode of the TFT element Tr.

In addition, the semiconductor layer 603 has a configuration that, for example, a source diffusion layer and a drain diffusion layer made of a second amorphous silicon which is different from a first amorphous silicon in kind and concentration of impurities are laminated on an active layer (a channel formation layer) made of the first amorphous silicon. In addition, in this case, part of the video signal line DL and part of the pixel electrode PX run on the semiconductor layer 603 respectively and the parts so run on the semiconductor layer 603 concerned respectively function as a drain electrode and a source electrode of the TFT element Tr.

Incidentally, the source and the drain of the TFT element Tr exchange their functions with each other depending on a bias relation, that is, a level relation between the potential of the pixel electrode PX and the potential of the video signal line DL when the TFT element Tr has been turned ON. However, in the following description in the present specification, an electrode which is connected to the video signal line DL will be referred to as the drain electrode and an electrode which is connected to the pixel electrode will be referred to as the source electrode. A third insulation layer 605 (an organic passivation film) the surface of which is flattened is formed on the second insulation layer 604. The common electrode CT and an alignment film 606 which covers the common electrode CT and the third insulation layer 605 are formed on the third insulation layer 605.

The common electrode CT is connected with the communization wiring CL through a contact hole (a through-hole) formed through the first insulation layer 602, the second insulation layer 604 and the third insulation layer 605. In addition, the common electrode CT is formed such that, for example, a gap Pg between the common electrode CT and the pixel electrode PX on a plane reaches about 7 μm. The alignment film 606 is coated with a polymer material described in any of the following embodiments and surface treatment for imparting liquid crystal aligning property is performed on a surface of the alignment film 606.

On the other hand, in the counter substrate 107, a black matrix 702, color filters 703R, 703G and 703B and an over-coat layer 704 which covers the above-mentioned elements are formed on a surface of an insulation substrate such as a glass substrate 701 or the like. The black matrix 702 is a grid-like light shielding film adapted to provide, for example, a pixel-wise aperture region in the display region DA. In addition, the color filters 703R, 703G and 703B are films which make only light in a specific wavelength range (colors) in white light emitted from the backlight 105 transmit. When the liquid crystal display device is configured so as to cope with RGB system color display, the color filter 703R which makes red light transmit, the color filter 703G which makes green light transmit and the color filter 703B which makes blue light transmit are arranged (here, one color pixel is representatively illustrated).

In addition, the surface of the over-coat layer 704 is flattened and the plurality of columnar spacers 110 and the alignment film 705 are formed on the active matrix substrate side of the over-coat layer 704. The columnar spacer 110 has, for example, a truncated cone shape the top of which is flattened (also called a trapezoidal rotor in some cases) and is formed at a position overlapping with a part of the scan signal line GL of the active matrix substrate 106 other than a part where the TFT element Tr is arranged and a part intersecting with the video signal line DL. In addition, the alignment film 705 is made of, for example, a polyimide-based resin and surface treatment for affording the liquid crystal aligning property is performed on the surface of the alignment film 705.

In addition, liquid crystal molecules 111 in the liquid crystal layer LC of the liquid crystal display panel 101 of the system illustrated in FIG. 8 are homogeneously aligned while being aligned in almost parallel with the surfaces of the glass substrates 601 and 701 and while being directed in an initial alignment direction defined by alignment regulation force application treatment performed on the alignment films 606 and 705 when no electric field is applied that the potentials of the pixel electrode PX and the common electrode CT are equal to each other. Then, when the TFT element Tr is turned on to write the gradation voltage applied to the video signal line DL into the pixel electrode PX and thus a potential difference is generated between the pixel electrode PX and the common electrode CT, such an electric field (a line of electric force) 112 as illustrated in the drawing is generated and the electric field 112 of an intensity corresponding to the potential difference between the pixel electrode PX and the common electrode CT is applied to the liquid crystal molecule 111.

At that time, since the liquid crystal molecules 111 which configure the liquid crystal layer LC turn toward the electric field 112 by interaction between dielectric anisotropy that the liquid crystal layer LC has and the electric field 112, refractive index anisotropy of the liquid crystal layer LC is changed. In addition, at that time, the orientation of the liquid crystal molecule 111 is determined in accordance with the intensity (the magnitude of the potential difference between the pixel electrode PX and the common electrode CT) of the electric field 112 to be applied. Therefore, in the liquid crystal display device, it is possible to display a video and an image, for example, by fixing the potential of the common electrode CT and controlling the gradation voltage to be applied to the pixel electrode PX per pixel to change the light transmittance of each pixel. Incidentally, it is also possible to configure the pixel electrode as a wall type pixel electrode.

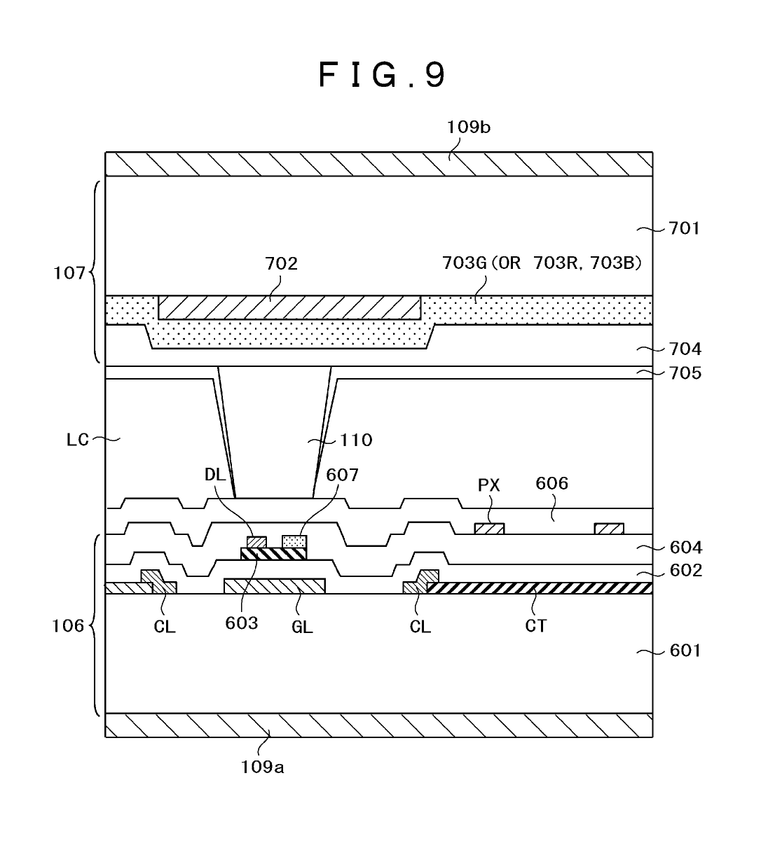

FIG. 9 is a schematic diagram illustrating one example of a schematic configuration of the FFS system liquid crystal display panel according to the present embodiment. In the active matrix substrate 106, the common electrode CT, the scan signal lines GL, the communization wiring CL and the first insulation layer 602 which covers the above-mentioned elements are formed on the surface of the insulation substrate such as the glass substrate 601 or the like. The semiconductor layer 603 of the TFT element Tr, the video signal lines DL, the source electrode 607 and the second insulation layer 604 which covers the above-mentioned elements are formed on the first insulation layer 602. In this case, part of the video signal line DL and part of the source electrode 607 respectively run on the semiconductor layer 603 and the parts so run on the semiconductor layer 603 concerned respectively function as the drain electrode and the source electrode of the TFT element Tr.

In addition, in the liquid crystal display panel 101 illustrated in FIG. 9, the third insulation layer 605 is not formed and the pixel electrode PX and the alignment film 606 which covers the pixel electrode PX are formed on the second insulation layer 604. Although not illustrated in the drawing here, the pixel electrode PX is connected with the source electrode 607 through a contact hole (a through-hole) formed through the second insulation layer 604. In this case, the common electrode CT which is formed on the surface of the glass substrate 601 is formed in a planar shape in a region (an aperture region) surrounded by the two adjacent scan signal lines GL and the two adjacent video signal lines DL and the pixel electrode PX having a plurality of slits is laminated above the planar common electrode CT concerned. In addition, in this case, the common electrodes CT of the pixels which are arrayed in an extension direction of the scan signal line GL are communized by the communization wiring CL. On the other hand, the counter substrate 107 of the liquid crystal display panel 101 in FIG. 9 has the same configuration as the counter substrate 107 of the liquid crystal display panel 101 in FIG. 8. Thus, detailed description on the configuration of the counter substrate 107 is omitted.

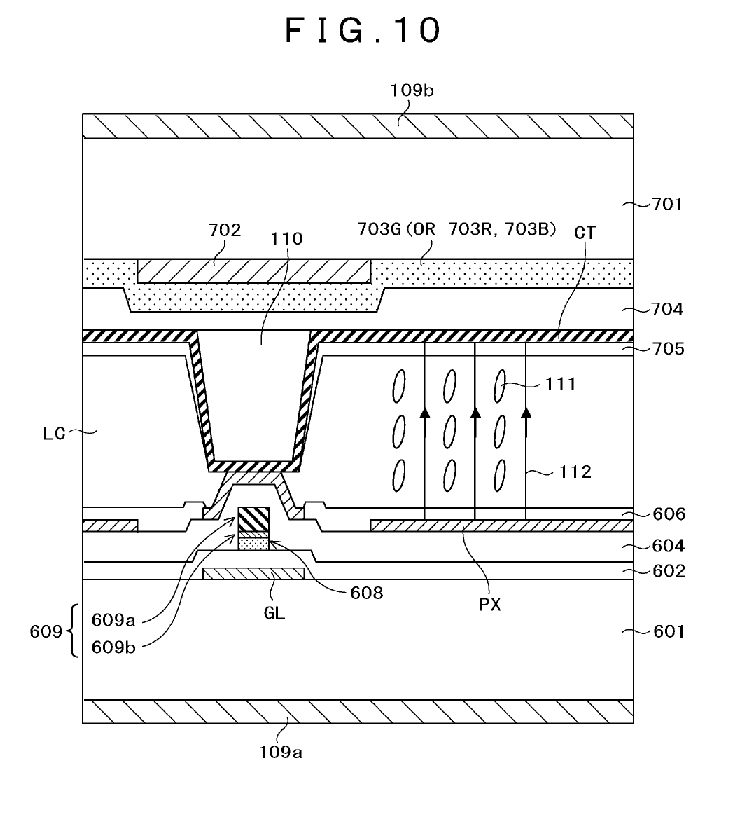

FIG. 10 is a schematic sectional diagram illustrating one example of a sectional configuration of a main part of the VA system liquid crystal display panel according to the present embodiment. In the liquid crystal display panel 101 of the vertical electric field driving system, the pixel electrode PX is formed on the active matrix substrate and the common electrode CT is formed on the counter substrate, for example, as illustrated in FIG. 10. In case of the liquid crystal display panel 101 of the VA system which is one of the vertical electric field driving systems, the pixel electrode PX and the common electrode CT are formed in a solid shape (a simple planar shape), for example, by a transparent conductor such as an ITO and so forth.

In the above-mentioned case, the liquid crystal molecules 111 are arrayed vertically relative to the surfaces of the glass substrates 601 and 701 by the alignment films 606 and 705 when no electric field is applied that the potentials of the pixel electrode PX and the common electrode CT are equal to each other. Then, when the potential difference is generated between the pixel electrode PX and the common electrode CT, the electric field (the line of electric force) 112 which is almost vertical to the glass substrates 601 and 701 is generated, the liquid crystal molecules 111 fall down in a direction parallel with the glass substrates 601 and 701 and a polarized state of incident light is changed. In addition, in the above-mentioned case, the orientation of the liquid crystal molecules 111 is determined in accordance with the intensity of the electric field 112 to be applied.

Therefore, in the liquid crystal display device, the video and the image are displayed, for example, by fixing the potential of the common electrode CT and controlling the video signal (the gradation voltage) to be applied to the pixel electrode PX per pixel to change the light transmittance of each pixel. In addition, various configurations are known as the configuration of the pixel in the VA system liquid crystal display panel 101 such as, for example, planar shapes of the TFT element Tr and the pixel electrode PX and any of the above-mentioned configurations may be adopted as the configuration of the pixel in the liquid crystal display panel 101 of the system illustrated in FIG. 10. Here, detailed description on the configuration of the pixel in that liquid crystal display panel 101 is omitted. Incidentally, reference numeral 608 denotes a conductive layer, reference numeral 609 denotes a projection formation member, reference numeral 609a denotes a semiconductor layer of the projection formation member and reference numeral 609b denotes a conductive layer of the projection formation member.

The present embodiment relates to the configurations of parts which are in contact with the liquid crystal layer LC and peripheries thereof in the liquid crystal panel 101, in particular, in the active matrix substrate 106 and the counter substrate 107 in the active matrix system liquid crystal display device as mentioned above. Therefore, detailed description on configurations which are not directly related to the present invention and the configurations of the well-known first drive circuit 102, second drive circuit 103, control circuit 104 and backlight 105 is omitted.

In order to manufacture the above-mentioned liquid crystal display devices, it is possible to use various alignment film materials, various alignment treatment methods and various liquid crystal materials and so forth which are already used in existing liquid crystal display devices and it is also possible to apply various processes used when assembling the above-mentioned elements to the liquid crystal display device.

Although the present invention will be described in more detail using embodiments in the following, the technical scope of the present invention is not limited to the following embodiments.

### First Embodiment

First, a result of production of factor elements of the liquid crystal display device configured such that the alignment film is coated using the alignment film material with which although liquid crystal alignment regulation force is applied to the alignment film surface on the periphery of the convex structure up to the vicinity of the inclined part of the convex structure, the surface of the inclined part of the convex structure has almost no alignment regulation force will be described using tables.

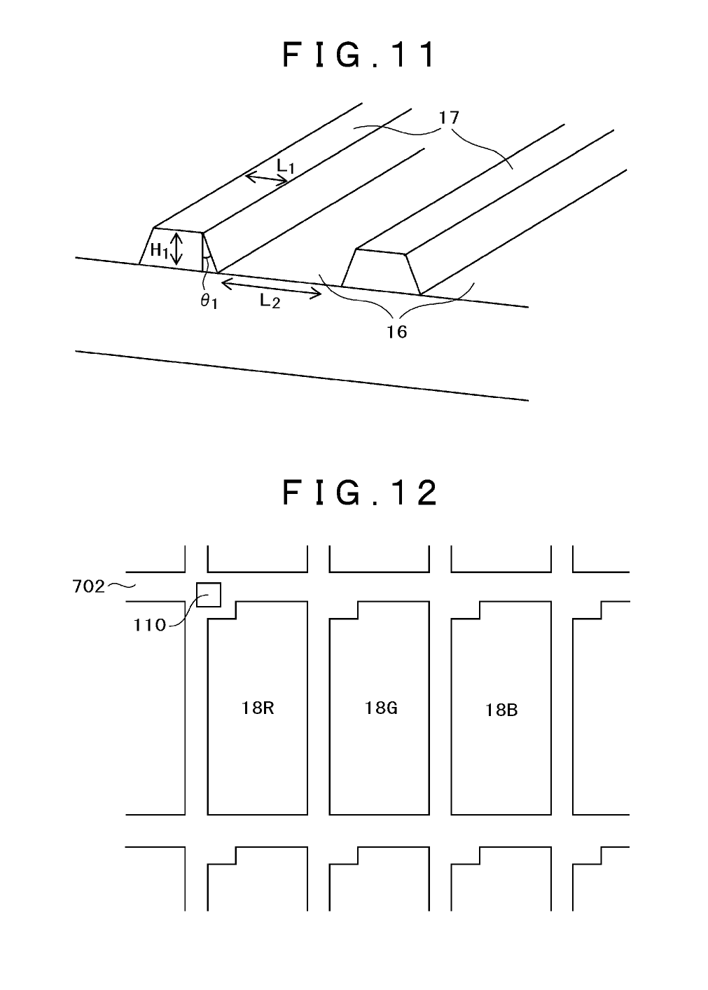

FIG. 11 schematically illustrates one example of a sectional structure of the convex structure which is one of the factor elements of the liquid crystal display device. Here, a convex structure 17 made of a photo-curing epoxy-acrylic resin was formed on a glass substrate (a base substrate) 16. The stripe-shaped convex structure 17 having a height H₁, an upper base size L₁ and a characteristic angle θ1 (90°−φ relative to the inclination angle φ) and having a trapezoidal section was formed and the plurality of convex structures 17 were arranged at intervals of L₂. Here, a substrate which was made of non-alkali glass (Asahi Glass AN-100) and on which the convex structures 17 each having a predetermined shape were formed was used as the base substrate, the substrate was washed with a liquid medicine such as a detergent and so forth before applying a precursor of the alignment film and thereafter the surface of the substrate was cleaned by UV/O₃ treatment.

Such a test alignment film as expressed below was used. With respect to the backbone of polyamide acid which would be a precursor of the polyimide expressed by [Chemical Formula 2], as a component of the first alignment film,

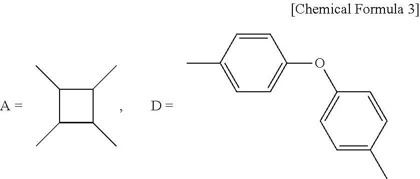

such a chemical structure as expressed above was selected and the polyamide acid was synthesized from acid dianhydride and diamine as raw materials following an existing chemical synthetic process.

The precursor of the component of this alignment film was dissolved in a mixture of various solvents such as buthyl cellosolve, N-methylpyrolidone, γ-butyrolactone and so forth in a predetermined ratio. The precursor was printed on the predetermined base substrate and thinned by flexographic printing and temporarily dried at a temperature of at least about 40° C., and thereafter was imidized in a bake furnace at a temperature of at least about 150° C. Thinning conditions were adjusted in advance so as to obtain a film thickness of about 100 nm at that time. Next, in order to apply the liquid crystal alignment regulation force by cutting some molecule backbones of a polymer compound with polarized light, polarized ultraviolet rays (having a main wavelength of about 280 nm) were collected and radiated by an ultraviolet lamp (a low-pressure mercury lamp), a wire grid polarizer and an interference filter. Here, an alignment film with the collimation optical system in FIG. 4 added and an alignment film subjected to ultraviolet irradiation with no addition of the optical system were produced. The diffusion angle of the former was about 1° and the diffusion angle of the latter was about 8°. In irradiation, the illuminance of the ultraviolet rays with which each alignment film is to be irradiated was measured and the irradiation time was adjusted so as to obtain the same irradiated light amount.

As for decision of presence/absence of the alignment regulation force on the alignment film on the substrate equipped with the convex structure so obtained, a material which had been immersed in a high sensitive fluorescent thiol (HS—(CH2)m-Triphenylimidazole: produced by Pro Chimia Co., Ltd.) solution, rinsed and naturally dried was used as a fluorescence observation sample. This sample was observed using a fluorescent microscope (Aqua Cosmos V1.3: manufactured by Hamamastu Photonics K.K.) and bright field observation (excitation ultraviolet rays were made to be vertically incident upon the substrate plane) and dark field observation (the excitation ultraviolet rays were made to be obliquely incident upon the substrate plane) were performed targeting on the convex structures. When fluorescence had been observed in the former and fluorescence had not been observed in the latter, it was decided that the alignment regulation force is not generated on the alignment film on the inclined part of the convex structure. (When fluorescence had been observed in both of the samples, it was decided that the alignment regulation force had been applied to the entire surfaces of the alignment films thereof, while when fluorescence had not been observed in both of the samples, it was decided that the alignment regulation force is insufficient on the both surfaces.)

In addition, as for a liquid crystal cell used for confirmation of liquid crystal alignment disorder, the substrate equipped with the alignment film so obtained was used, foreign matters on the surface were removed by pure water spin cleaning, end parts of the above-mentioned substrate and another substrate equipped with another alignment film which had been formed on the flat substrate on which the convex structure is not formed and had been subjected to alignment treatment by the same method as the above were sealed together with a photo-curing epoxy resin except a liquid crystal seal port, thereby forming an empty cell which contains no liquid crystal. In this case, the upper and lower substrates were aligned in parallel with each other. Next, a nematic liquid crystal was vacuum-sealed into the cell through the liquid crystal seal port, the seal port was closed with the photo-curing epoxy resin and the entire cell was heated at about 100° C. for about one hour to stabilize alignment of the liquid crystal. This liquid crystal cell was observed through a polarizing microscope (Olympus TH3) while bringing the polarizers of the upper and lower substrates into a crossed Nicol state and by targeting on the convex structure and presence/absence of light leakage was decided.

A result thereof is indicted in Table 1.

TABLE 1

| | | | | | | Inclined | |
|---|---|---|---|---|---|---|---|
| | | | | Fluorescence | | Part | |
| | | | | Generation | | Alignment | |
| Light | H₁ | θ₁ | θ₂ | Bright | Dark | Regulation | Alignment |
| Source | (μm) | (deg) | (deg) | Field | Field | Force | Disorder |
| Collimated | 2 | 20 | 22 | Presence | Presence | Presence | Presence |
| Light | 2 | 10 | 11 | Presence | Presence | Presence | Presence |
| | 2 | 5 | 7 | Presence | Presence | Presence | Presence |
| | 2 | 2 | 4 | Presence | Absence | Absence | Absence |
| | 2 | 0 | 2 | Presence | Absence | Absence | Absence |
| | 2 | −2 | 0 | Presence | Absence | Absence | Absence |
| | 4 | 20 | 22 | Presence | Presence | Presence | Presence |
| | 4 | 10 | 11 | Presence | Presence | Presence | Presence |
| | 4 | 5 | 7 | Presence | Presence | Presence | Presence |
| | 4 | 2 | 4 | Presence | Absence | Absence | Absence |
| | 4 | 0 | 2 | Presence | Absence | Absence | Absence |
| | 4 | −2 | 0 | Presence | Absence | Absence | Absence |
| | 6 | 20 | 22 | Presence | Presence | Presence | Presence |
| | 6 | 10 | 11 | Presence | Presence | Presence | Presence |
| | 6 | 5 | 7 | Presence | Presence | Presence | Presence |
| | 6 | 2 | 4 | Presence | Absence | Absence | Absence |
| | 6 | 0 | 2 | Presence | Absence | Absence | Absence |
| | 6 | −2 | 0 | Presence | Absence | Absence | Absence |
| Non- | 2 | 20 | 22 | Presence | Presence | Presence | Presence |
| Collimated | 2 | 10 | 11 | Presence | Presence | Presence | Presence |
| Light | 2 | 5 | 7 | Presence | Presence | Presence | Presence |
| | 2 | 2 | 4 | Presence | Presence | Presence | Presence |
| | 2 | 0 | 2 | Presence | Presence | Presence | Presence |
| | 2 | −2 | 0 | Presence | Presence | Presence | Presence |
| | 4 | 20 | 22 | Presence | Presence | Presence | Presence |
| | 4 | 10 | 11 | Presence | Presence | Presence | Presence |
| | 4 | 5 | 7 | Presence | Presence | Presence | Presence |
| | 4 | 2 | 4 | Presence | Presence | Presence | Presence |
| | 4 | 0 | 2 | Presence | Presence | Presence | Presence |
| | 4 | −2 | 0 | Presence | Presence | Presence | Presence |
| | 6 | 20 | 22 | Presence | Presence | Presence | Presence |
| | 6 | 10 | 11 | Presence | Presence | Presence | Presence |
| | 6 | 5 | 7 | Presence | Presence | Presence | Presence |
| | 6 | 2 | 4 | Presence | Presence | Presence | Presence |
| | 6 | 0 | 2 | Presence | Presence | Presence | Presence |
| | 6 | −2 | 0 | Presence | Presence | Presence | Presence |

Here, respective values were set such that L1=10 μm and L2=100 μm, and 2 μm, 4 μm or 6 μm was selected as a value of H₁ (=2 μm, 4 μm and 6 μm) and 20°, 10°, 5°, 2°, 0° or −2° was selected as a value of θ₁ (=2°, 10°, 5°, 2°, 0° and −2°). In addition, the printing conditions were adjusted such that the film thickness of the applied alignment film reaches 100 nm when formed on the flat substrate. As a result of observation of cross-sectional SEM images on 20 spots at a position corresponding to an intermediate height of the heights of the upper and lower flat parts and acquisition of an average characteristic angle (referred to as θ₂) thereof with respect to the alignment film on the inclined part of the convex structure in the above-mentioned situation, a standard deviation thereof was held within a range of the characteristic angle+2° of the convex structure. In addition, here, the alignment regulation force was applied by using two kinds of ultraviolet light sources, that is a light source of collimated ultraviolet rays and a light source of not-collimated ultraviolet rays and the irradiated light amount of each light source was adjusted to 7j/cm². It is seen from the result in Table 1 that when the collimated light has been used, several conditions under which although florescence is observed in bright field observation through a fluorescent microscope, no fluorescence is observed, that is the inclined part alignment regulation force is not generated in dark field observation are found and the characteristic angle of the alignment film on the inclined part is not more than 4° (the inclination angle=at least 86°) under the above-mentioned conditions. In addition, the alignment disorder does not occur in the liquid crystal cells of the conditions corresponding to the above. On the other hand, when the not-collimated light had been used, a condition under which the alignment regulation force is not generated on the inclined part and a condition under which the alignment disorder does not occur were not found in any cell. Incidentally, when a fluorescence intensity in the dark field is not more than a detection level which has been defined in the following way in comparison with a fluorescence intensity in the bright field, it is possible to regard that the liquid crystal alignment regulation force is not generated (not applied). That is, although in decision of presence/absence of the alignment regulation force on the inclined part of the convex structure of the actual liquid crystal panel, measurement is made by focusing the observation field on the inclined part to the greatest possible extent, since a fixed wide region is typically irradiated with fluorescent excitation light, fluorescent stray light from a region other than the inclined part may possibly be mixed into the light. Therefore, decision of presence/absence of fluorescence on the inclined part was made in the following procedures by taking influence of the stray light into account. First, a single-film sample of the photo-alignment film on which film deposition processes such as imidization reaction, photo-alignment treatment and so forth has been performed and finally high-sensitive fluorescent thiol treatment has been performed under the same condition as that when the liquid crystal panel is generally produced by coating the photo-alignment film to be observed onto the flat glass substrate is prepared. In this case, samples obtained by gradually increasing the amount of polarized ultraviolet rays used when performing the photo-alignment treatment are prepared. When fluorescence observation is performed on the above-mentioned single-film samples of the photo-alignment film in a bright field mode using the above-mentioned fluorescent microscope, although the intensity of fluorescence generated is increased with increasing the amount of polarized ultraviolet rays used in the photo-alignment treatment, a rate of increase in the intensity is decreased in due time and the intensity of fluorescence generated becomes constant in the samples which are sufficiently large in amount of the polarized ultraviolet rays. The intensity of fluorescence obtained at that time is defined as F1. Next, when fluorescence observation is performed on the same single-film samples of the photo-alignment film in a dark field mode using the fluorescent microscope, fluorescence of the same spectrum pattern is observed. The intensity of fluorescence obtained at that time is defined as F2. When comparing a F1-to-F2 ratio k=F2/F1, F2 indicated the intensity of fluorescence which is about 5% to about 10% of that of F1 by a measurement system used in the present embodiment. Since the same ratio was also obtained from a sample that the amount of polarized ultraviolet ray used in photo-alignment treatment had been changed, this ratio is thought to be a ratio of an amount of fluorescence generated due to a difference between measurement modes peculiar to the fluorescent microscope used. In a case where after the bright filed-to-dark field fluorescence intensity ratio k had been obtained in advance and then after fluorescence intensity observation had been performed on the inclined part of the actual pixel structure and fluorescence in an observation region had been measured in the bright field (the intensity of fluorescence obtained at that time is defined as G1) in this way, the fluorescence intensity obtained when the same region had been observed in the dark field was not more than G1×k×½, it was decided that fluorescence had not been generated on the inclined part.

From the above, it was confirmed that it is possible to suppress liquid crystal alignment disorder in the vicinity of the inclined part because the alignment film is coated using the alignment film material with which although the liquid crystal alignment regulation force is applied to the alignment film surface on the periphery of the convex structure up to the vicinity of the inclined part of the convex structure, the surface of the inclined part of the convex structure has almost no alignment regulation force. Incidentally, it is possible to evaluate the quality of the alignment film even over a large area (the entire surface of the panel) by this method.

Accordingly, when such a liquid crystal display device as having a fine pixel (about 120 μm vertically×about 40 μm horizontally) and a high aperture ratio (about 61%) as illustrated in FIG. 8 had been produced such that the height of the convex structure would be about 4 μm, the characteristic angle of its inclined part would be about 0° and the characteristic angle of the alignment film to be formed on the convex structure would be about 2°, it was possible to obtain a high definition and high quality image.

As described above, according to the present embodiment, it is possible to provide the high definition and high quality liquid crystal display device, the manufacturing method for the liquid crystal display device and the liquid crystal alignment regulation force decision method of evaluating the quality of the alignment film on the entire surface of the panel of a photo-alignment type liquid crystal alignment film suitable for the liquid crystal display device even when the pixel has been more miniaturized and the aperture ratio of the display region of the pixel has been more increased. Incidentally, when the convex structure is formed on the glass substrate, it is effective to set the characteristic angle of the alignment film to not more than about 4°.

### Second Embodiment

Next, a result of evaluation performed on samples produced on other base substrates using the element producing conditions described in the embodiment 1 will be described using a table. Incidentally, matters described in the embodiment 1 and not described in the present embodiment are applicable to the present embodiment unless there are special circumstances.

Here, the samples which are the same in configuration as those in the embodiment 1, in each of which a substrate prepared by sputter-coating a solid ITO (about 70 nm in film thickness) on a glass substrate is used as the base in place of the glass substrate and which are the same in condition as those in the embodiment 1 in other respects were produced.

The result is indicated on Table 2.

TABLE 2

| | | | | | | Inclined | |
|---|---|---|---|---|---|---|---|
| | | | | Fluorescence | | Part | |
| | | | | Generation | | Alignment | |
| Light | H₁ | θ₁ | θ₂ | Bright | Dark | Regulation | Alignment |
| Source | (μm) | (deg) | (deg) | Field | Field | Force | Disorder |
| Collimated | 2 | 20 | 21 | Presence | Presence | Presence | Presence |
| Light | 2 | 10 | 11 | Presence | Presence | Presence | Presence |
| | 2 | 5 | 6 | Presence | Presence | Presence | Presence |
| | 2 | 2 | 3 | Presence | Absence | Absence | Absence |
| | 2 | 0 | 1 | Presence | Absence | Absence | Absence |
| | 2 | −2 | 0 | Presence | Absence | Absence | Absence |
| | 4 | 20 | 21 | Presence | Presence | Presence | Presence |
| | 4 | 10 | 10 | Presence | Presence | Presence | Presence |
| | 4 | 5 | 5 | Presence | Absence | Absence | Absence |
| | 4 | 2 | 2 | Presence | Absence | Absence | Absence |
| | 4 | 0 | 0 | Presence | Absence | Absence | Absence |
| | 4 | −2 | 0 | Presence | Absence | Absence | Absence |
| | 6 | 20 | 20 | Presence | Presence | Presence | Presence |
| | 6 | 10 | 10 | Presence | Presence | Presence | Presence |
| | 6 | 5 | 5 | Presence | Absence | Absence | Absence |
| | 6 | 2 | 2 | Presence | Absence | Absence | Absence |
| | 6 | 0 | 0 | Presence | Absence | Absence | Absence |
| | 6 | −2 | 0 | Presence | Absence | Absence | Absence |
| Non- | 2 | 20 | 21 | Presence | Presence | Presence | Presence |
| Collimated | 2 | 10 | 11 | Presence | Presence | Presence | Presence |
| Light | 2 | 5 | 6 | Presence | Presence | Presence | Presence |
| | 2 | 2 | 3 | Presence | Presence | Presence | Presence |
| | 2 | 0 | 1 | Presence | Presence | Presence | Presence |
| | 2 | −2 | 0 | Presence | Presence | Presence | Presence |
| | 4 | 20 | 21 | Presence | Presence | Presence | Presence |
| | 4 | 10 | 10 | Presence | Presence | Presence | Presence |
| | 4 | 5 | 5 | Presence | Presence | Presence | Presence |
| | 4 | 2 | 2 | Presence | Presence | Presence | Presence |
| | 4 | 0 | 0 | Presence | Presence | Presence | Presence |
| | 4 | −2 | 0 | Presence | Presence | Presence | Presence |
| | 6 | 20 | 20 | Presence | Presence | Presence | Presence |
| | 6 | 10 | 10 | Presence | Presence | Presence | Presence |
| | 6 | 5 | 5 | Presence | Presence | Presence | Presence |
| | 6 | 2 | 2 | Presence | Presence | Presence | Presence |
| | 6 | 0 | 0 | Presence | Presence | Presence | Presence |
| | 6 | −2 | 0 | Presence | Presence | Presence | Presence |

It is seen from Table 2 that some conditions under which the inclined part alignment regulation force is not generated are found and the characteristic angle of the alignment film on the inclined part is not more than about 5° (the inclination angle: at least about 85°) under these conditions. In addition, in the liquid crystal cells of the conditions corresponding to the above, the alignment disorder does not occur. On the other hand, when the not-collimated light had been used, a condition under which the alignment regulation force is not generated on the inclined part and a condition under which the alignment disorder does not occur were not found in any cell.

From the above, it was confirmed that it is possible to suppress the liquid crystal alignment disorder in the vicinity of the inclined part because the alignment film is coated using the alignment film material with which although the liquid crystal alignment regulation force is applied to the alignment film surface on the periphery of the convex structure up to the vicinity of the inclined part of the convex structure, the surface of the inclined part of the convex structure generally has almost no alignment regulation force.

Accordingly, when such a liquid crystal display device as having a fine pixel (about 120 μm vertically×about 40 μm horizontally) and a high aperture ratio (about 61%) as illustrated in FIG. 10 had been produced such that the height of the convex structure (a columnar spacer) would be about 4 μm, the characteristic angle of its inclined part would be about 2° and the characteristic angle of the alignment film to be formed on the convex structure would be about 2°, it was possible to obtain a high definition and high quality image.

As described above, according to the present embodiment, it is possible to obtain the same effect as that by the embodiment 1. Incidentally, when the convex structure is formed on the glass substrate with an ITO film formed, it is effective to set the characteristic angle of the alignment film to not more than about 5°.

### Third Embodiment

Next, a result of evaluation performed on samples produced on other base substrates using the element producing conditions described in the embodiment 1 will be described using a table. Incidentally, matters described in the embodiment 1 and not described in the present embodiment are applicable to the present embodiment unless there are special circumstances.

Here, the samples which are the same in configuration as those in the embodiment 1, in each of which a substrate prepared by sputter-coating a solid SiN (about 120 nm in film thickness) on a glass substrate is used as the base in place of the glass substrate and which are the same in condition as those in the embodiment 1 in other respects were produced.

The result is indicated on Table 3.

TABLE 3

| | | | | | | Inclined | |
|---|---|---|---|---|---|---|---|
| | | | | Fluorescence | | Part | |
| | | | | Generation | | Alignment | |
| Light | H₁ | θ₁ | θ₂ | Bright | Dark | Regulation | Alignment |
| Source | (μm) | (deg) | (deg) | Field | Field | Force | Disorder |
| Collimated | 2 | 20 | 24 | Presence | Presence | Presence | Presence |
| Light | 2 | 10 | 12 | Presence | Presence | Presence | Presence |
| | 2 | 5 | 8 | Presence | Presence | Presence | Presence |
| | 2 | 2 | 6 | Presence | Presence | Presence | Presence |
| | 2 | 0 | 4 | Presence | Absence | Absence | Absence |
| | 2 | −2 | 1 | Presence | Absence | Absence | Absence |
| | 4 | 20 | 23 | Presence | Presence | Presence | Presence |
| | 4 | 10 | 12 | Presence | Presence | Presence | Presence |
| | 4 | 5 | 7 | Presence | Presence | Presence | Presence |
| | 4 | 2 | 5 | Presence | Absence | Absence | Absence |
| | 4 | 0 | 3 | Presence | Absence | Absence | Absence |
| | 4 | −2 | 1 | Presence | Absence | Absence | Absence |
| | 6 | 20 | 22 | Presence | Presence | Presence | Presence |
| | 6 | 10 | 11 | Presence | Presence | Presence | Presence |
| | 6 | 5 | 6 | Presence | Presence | Presence | Presence |
| | 6 | 2 | 4 | Presence | Absence | Absence | Absence |
| | 6 | 0 | 2 | Presence | Absence | Absence | Absence |
| | 6 | −2 | 0 | Presence | Absence | Absence | Absence |
| Non- | 2 | 20 | 24 | Presence | Presence | Presence | Presence |
| Collimated | 2 | 10 | 12 | Presence | Presence | Presence | Presence |
| Light | 2 | 5 | 8 | Presence | Presence | Presence | Presence |
| | 2 | 2 | 6 | Presence | Presence | Presence | Presence |
| | 2 | 0 | 4 | Presence | Presence | Presence | Presence |
| | 2 | −2 | 1 | Presence | Presence | Presence | Presence |
| | 4 | 20 | 23 | Presence | Presence | Presence | Presence |
| | 4 | 10 | 12 | Presence | Presence | Presence | Presence |
| | 4 | 5 | 7 | Presence | Presence | Presence | Presence |
| | 4 | 2 | 5 | Presence | Presence | Presence | Presence |
| | 4 | 0 | 3 | Presence | Presence | Presence | Presence |
| | 4 | −2 | 1 | Presence | Presence | Presence | Presence |
| | 6 | 20 | 22 | Presence | Presence | Presence | Presence |
| | 6 | 10 | 11 | Presence | Presence | Presence | Presence |
| | 6 | 5 | 6 | Presence | Presence | Presence | Presence |
| | 6 | 2 | 4 | Presence | Presence | Presence | Presence |
| | 6 | 0 | 2 | Presence | Presence | Presence | Presence |
| | 6 | −2 | 0 | Presence | Presence | Presence | Presence |

It is seen from Table 3 that some conditions under which the inclined part alignment regulation force is not generated are found and the characteristic angle of the alignment film on the inclined part is not more than about 5° (the inclination angle: at least about 85°) under these conditions. In addition, in the liquid crystal cells having the conditions corresponding to the above, the alignment disorder does not occur. On the other hand, when the not-collimated light had been used, a condition under which the alignment regulation force is not generated on the inclined part and a condition under which the alignment disorder does not occur were not found in any cell.

From the above, it was confirmed that it is possible to suppress the liquid crystal alignment disorder in the vicinity of the inclined part because the alignment film is coated using the alignment film material with which although the liquid crystal alignment regulation force is applied to the alignment film surface on the periphery of the convex structure up to the vicinity of the inclined part of the convex structure, the surface of the inclined part of the convex structure has almost no alignment regulation force.

Accordingly, when such a liquid crystal display device as having a fine pixel (about 120 μm vertically×about 40 μm horizontally) and a high aperture ratio (about 61%) as illustrated in FIG. 9 had been produced such that the characteristic angle of the alignment film to be formed on the convex structure (unevenness on the TFT substrate side) would be about 5°, it was possible to obtain a high definition and high quality image.

As described above, according to the present embodiment, it is possible to obtain the same effect as that by the embodiment 1. Incidentally, when the convex structure is formed on the glass substrate with the SiN film formed, it is effective to set the characteristic angle of the alignment film to not more than about 5°.

### Fourth Embodiment

Next, a result that the IPS system liquid crystal display device which has the photo-alignment film formed by taking the characteristic angle of the inclined plane of the convex structure into account has been produced and contract characteristics of the device has been evaluated will be described using a table. This embodiment is also applicable to liquid crystal display devices of other systems. In addition, matters described in any of the embodiments 1 to 3 and not described in the present embodiment are also applicable to the present embodiment unless there are special circumstances.

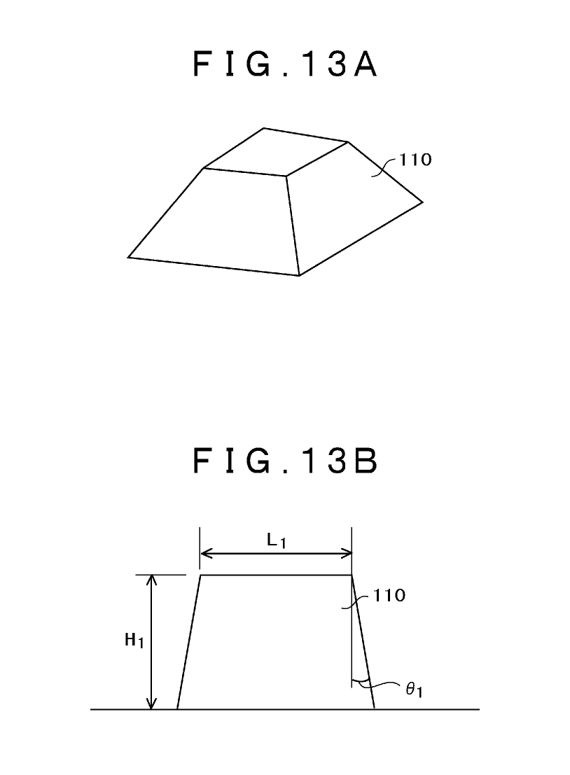

FIG. 12 is a schematic plan view illustrating one example of pixel arrangement in the counter electrode of the liquid crystal display device for characteristic evaluation. Here, 18R, 18G and 18B respectively denote pixel regions of red (R), green (G) and blue (B) and these three adjacent pixels were defined as one set of display pixels. Respective pixel regions are partitioned by the black matrix 702 and the columnar spacer 110 is provided at a position of an intersection of the black matrix (here, one columnar spacer was arranged for every 10 sets of display regions in longitudinal and lateral directions). The size of one set of display pixels was about 120 μm vertically×about 120 μm horizontally (about 120 μm vertically×about 40 μm horizontally per pixel), the black matrix width in a horizontal direction was about 20 μm, the black matrix width in a vertical direction was about 10 μm, and a left upper part of each pixel, that is, the part which is protruded into the pixel region was about 5 μm vertically×about 10 μm horizontally. The aperture ratio in design is about 61%. Wide-UXGA of 1920 pixels vertically×1200 pixels horizontally was adopted as the specification of the resolution of the entire liquid crystal display device. FIG. 13A and FIG. 14B schematically illustrate examples of a structure of the columnar spacer 110 formed on the counter substrate of the liquid crystal display device for characteristic evaluation. FIG. 13A is a bird's-eye view and FIG. 13B is a sectional diagram in the vertical direction. Here, the columnar spacer 110 was formed as a spacer having a regular quadrangle base shape and the shape was depicted with the height H₁, the upper side L₁ and the characteristic angle θ₁ (it becomes possible to adopt the conditions in studies on the inclination of the peripheral part of the convex structure which has been studied in the embodiments 1 to 3 by forming the spacer 110 into such a shape). The columnar spacer 110 having the regular quadrangle base shape is arranged such that the respective sides of its quadrangular part may run in parallel with vertical and horizontal lines of each pixel and its central part may be positioned at the center of the upper left corner region of the pixel as illustrated in FIG. 12.

The contrast of the liquid crystal display device was obtained in the following procedures. The liquid crystal display device was aligned to be normally black (parallel alignment that the transmittance is minimized when no voltage is applied) and a contrast ratio=Iₘₐₓ/I₀ was defined when a transmitted light amount I₀ obtained when the applied voltage was 0V and a transmitted light amount Iₘₐₓ (an almost maximum light amount) obtained when the applied voltage was 10V had been measured by a luminance meter.

A result of the above measurement is indicated in Table 4.

TABLE 4

| | H₁ | θ₁ | L₁ | Contrast |
|---|---|---|---|---|
| Light Source | (μm) | (deg) | (μm) | Ratio |
| Collimated | 4 | 11 | 10 | 1050 |
| Light | 4 | 11 | 13 | 580 |
| | 4 | 4 | 10 | 1300 |
| | 4 | 4 | 13 | 700 |
| Not-Collimated | 4 | 11 | 10 | 950 |
| Light | 4 | 11 | 13 | 550 |
| | 4 | 4 | 10 | 1100 |
| | 4 | 4 | 13 | 620 |

Table 4 indicates that, for example, when L₁=10 μm, the smaller the characteristic angle θ₁ is, the more the contrast is increased, and the contrast is increased more when the collimated light source is used than when the not-collimated light source is used. In addition, although a similar tendency is exhibited when L₁=13 μm, the contrast is greatly reduced when compared by using the same characteristic angle θ₁ and light sources. It is thought that the contrast has been reduced because the longitudinal width of the region where the columnar spacer 110 is placed is as narrow as about 15 μm and when the length of one side of the columnar spacer approaches this value, a region which is influenced by the alignment disorder of its peripheral part more intrudes into the pixel region than before.

Form the above, it has been confirmed that in the liquid crystal display device made of the alignment film material with which although the liquid crystal alignment regulation force is applied to the surface of the alignment film on the periphery of the convex structure up to the vicinity of the inclined part of the convex structure, the surface of the inclined part of the convex structure has almost no alignment regulation force as in the present embodiment, contrast capability is improved.

According to the present embodiment, it is possible to suppress the liquid crystal disorder on the periphery of the convex structure application of the alignment regulation force onto which is difficult so as to reduce light leakage therefrom and consequently it is possible to realize the high definition and high contrast liquid crystal display device.

Incidentally, the present invention is not limited to the above-mentioned embodiments and examples and various modified examples are included. For example, the above-mentioned embodiments and examples have been described in detail for ready understanding of the present invention and the present invention is not necessarily limited to those including all of the configurations described above. In addition, a part of one configuration of one embodiment or example may be replaced with one configuration of another embodiment or example. Further, one configuration of another embodiment or example may be added to one configuration of one embodiment or example. Still further, another configuration may be added to, deleted from and/or replaced with a part of one configuration of each embodiment or example.

What is claimed is:

1. A liquid crystal display device comprising: a TFT substrate that an alignment film is formed on a pixel which includes a pixel electrode and a TFT; a counter substrate which is arranged so as to face the TFT substrate and on the TFT substrate side of which an alignment film is formed; and a liquid crystal which is interposed and held between the alignment film of the TFT substrate and the alignment film of the counter substrate, wherein
the alignment film is made of a material capable of applying liquid crystal alignment regulation force by polarized light irradiation,
a convex structure is formed on the TFT substrate or the counter substrate, and
the alignment film is applied the liquid crystal alignment regulation force to a surface of a region ranging from the periphery of the convex structure to the vicinity of an inclined part of the convex structure and is not applied the liquid crystal alignment regulation force to a surface of the inclined part of the convex structure.

2. The liquid crystal display device according to claim 1, wherein an inclination angle of the convex structure is larger than about 85 degrees.

3. The liquid crystal display device according to claim 1, wherein the convex structure is a spacer adapted to maintain a distance between the TFT substrate and the counter substrate constant.

4. The liquid crystal display device according to claim 1, wherein the liquid crystal display device is an IPS system liquid crystal display device.

5. The liquid crystal display device according to claim 4,
wherein the IPS system liquid crystal display device includes a wall-type pixel electrode, and
the convex structure is the wall-type pixel electrode.

6. The liquid crystal display device according to claim 1, wherein the alignment film is a photodecomposition type photo-alignment film.

7. The liquid crystal display device according to claim 6, wherein the alignment film is the photodecomposition type photo-alignment film which contains a polyimide given by [Chemical Formula 1], where a structure in square brackets [ ] indicates a chemical structure of a repeating unit, a subscript n indicates the number of repeating units, N denotes a nitrogen atom, O denotes an oxygen atom, A denotes a quadrivalent organic group including a cyclobutane ring, and D denotes a bivalent organic group.

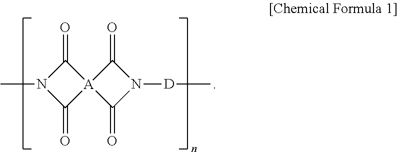

8. A liquid crystal alignment regulation force decision method for a liquid crystal display device which includes a TFT substrate that an alignment film is formed on a pixel including a pixel electrode and a TFT, a counter substrate which is arranged so as to face the TFT substrate and on the TFT substrate side of which an alignment film is formed, and a liquid crystal which is interposed and held between the alignment film of the TFT substrate and the alignment film of the counter substrate, wherein the alignment film is made of a photodecomposition type material capable of applying liquid crystal alignment regulation force by polarized light irradiation and a convex structure is formed on the TFT substrate or the counter substrate, comprising:
the irradiation step of irradiating the alignment film formed on the convex structure with ultraviolet rays;
the dyeing step of dyeing the alignment film so irradiated with the ultraviolet rays with a thiol derivative, and
the decision step of deciding presence/absence of the liquid crystal alignment regulation force from a fluorescence distribution of the dyed alignment film.

9. The liquid crystal alignment regulation force decision method according to claim 8, wherein in the decision step, the fluorescence distribution is obtained through bright-field observation and dark-field observation.

10. A manufacturing method for a liquid crystal display device which includes a TFT substrate that an alignment film is formed on a pixel including a pixel electrode and a TFT, a counter substrate which is arranged so as to face the TFT substrate and on the TFT substrate side of which an alignment film is formed, and a liquid crystal which is interposed and held between the alignment film of the TFT substrate and the alignment film of the counter substrate, wherein the alignment film is made of a material capable of applying liquid crystal alignment regulation force by polarized light irradiation and a convex structure is formed on the TFT substrate or the counter substrate, comprising:
the alignment film formation process of forming the alignment film on the convex structure; and thereafter,
the photo-alignment process of photo-aligning the alignment film by irradiating a surface of the substrate on which the alignment film is formed with polarized light collimated from a vertical direction.

11. The manufacturing method for the liquid crystal display device according to claim 10, wherein the alignment film formation process is performed such that an inclination angle of a side face of the alignment film reaches a value of at least about 85 degrees and not more than about 90 degrees.

12. The manufacturing method for the liquid crystal display device according to claim 10, wherein in the photo-alignment process, a light source of the polarized light is a long-arc type ultraviolet-ray lamp.
